(19) United States
(12) Patent Application Publication
(10) Pub. No.: US 2024/0347818 A1
(43) Pub. Date: Oct. 17, 2024

(54) POWER DISTRIBUTION CONTROLLER FOR HYBRID ELECTRIC VEHICLE

(71) Applicant: KING FAHD UNIVERSITY OF PETROLEUM AND MINERALS, Dhahran (SA)

(72) Inventors: Muhammad KHALID, Dhahran (SA); Muhammad MAARUF, Dhahran (SA)

(73) Assignee: KING FAHD UNIVERSITY OF PETROLEUM AND MINERALS, Dhahran (SA)

(21) Appl. No.: 18/298,688

(22) Filed: Apr. 11, 2023

(51) Int. Cl. H01M 16/00; B60W 20/00; H01M 8/04992; H02J 1/08; H02J 1/12; H02J 7/34

(52) U.S. Cl. CPC H01M 16/006; B60W 20/00; H01M 8/04992; H02J 1/084; H02J 1/12; H02J 7/345; H01M 2250/20; H02M 3/1582

(57) ABSTRACT

A passivity-based power distribution control system for a hybrid electric vehicle includes a proton-exchange membrane fuel cell module, a battery module, an ultra-capacitor module, an energy management controller, and a duty cycle controller. The proton-exchange membrane fuel cell module includes a proton-exchange membrane fuel cell (PEMFC) and a PEMFC boost converter. The PEMFC module generates a PEMFC current I_{FC}. The battery module includes a battery and a battery buck/boost converter. The battery module generates a battery current I_{b}. The ultra-capacitor module includes an ultra-capacitor (UC) and a UC buck/boost converter. The UC module generates a UC current I_{UC}. The duty cycle controller controls a PEMFC duty cycle D₁ of the PEMFC boost converter, a battery duty cycle D₂₃ of the battery buck/boost converter, and a UC duty cycle D₄₅ of the UC buck/boost converter.

### STATEMENT OF ACKNOWLEDGEMENT

The inventor(s) acknowledge the financial support by the Deanship of Research (DSR) at King Fahd University of Petroleum & Minerals (KFUPM) and by King Abdullah City for Atomic and Renewable Energy (K.A.CARE), through project No. DF201011.

### BACKGROUND

### Technical Field

The present disclosure is directed to a power distribution controller for hybrid electric vehicle.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Growing environmental pollution and continuous depletion of fossil fuels has led to the development of energy sources with zero carbon emissions. Among various energy sources and technologies to replace fossil fuels, hydrogen energy and fuel cells are considered promising solutions. Fuel-cell electric vehicles are playing an important role in replacing conventional vehicles that use fossil fuels.

Conventional fuel-cell electric vehicles use fuel cells, which use hydrogen energy as the energy source to generate electricity. The fuel cell directly converts the chemical energy contained in hydrogen into electricity, heat, and water. However, the fuel cells used in electric vehicles exhibit poor performance when subjected to high-frequency power fluctuations. Also, fuel cells have unidirectional energy flow and cannot recover regenerative braking energy. The fuel cell suffers from a slow dynamic response which limits its application for complex driving conditions. The chemical conversion rate of the hydrogen in the fuel cell to electrical energy is often lower than the rate of change of the load. At the same time, rapid acceleration and deceleration and frequent start-stop operations during driving will affect the durability of the fuel cell. Because of these shortcomings, the fuel cells are often used in a hybrid energy storage system in combination with other energy sources, such as batteries and ultracapacitors, for power applications. Batteries can recover excess energy and provide power to the system simultaneously with the fuel cells when the load demand power is high. Further, an ultracapacitor has the characteristics of a fast dynamic response, fast energy recovery, and high specific power, which can manage rapid changes in load demand. There are three main energy systems for a fuel cell hybrid electric vehicle (FCHEV). The first type is a hybrid system having fuel cells and batteries. The second type is a hybrid system composed of fuel cells and ultracapacitors. The third type is also a hybrid system composed of fuel cells, batteries, and ultracapacitors. The fuel cell serves as the primary power source while the battery and the ultra-capacitor serve as secondary power sources. The energy sources are connected to a Direct Current (DC)-bus through the DC-DC converters. The DC-bus transfers power to the Alternating Current (AC) motor via an inverter. The present disclosure describes a power management controller for the third type of hybrid system.

Allocating energy effectively to the three sources according to the load condition requires efficient control and energy management strategies. For example, an adaptive nonlinear control strategy was developed for the energy management of a polymer electrolyte membrane fuel cell and supercapacitor-based hybrid electric vehicle (See: H. A, I. A, al. eAN., “Nonlinear controller analysis of fuel cell-battery-ultracapacitor-based hybrid energy storage systems in electric vehicles”, Arab J Sci Eng 2018; 43: 3123-3133, incorporated herein by reference in its entirety). However, this reference does not include a battery in the control strategy.

A hierarchical energy management system was used in a FCHEV for minimizing the fuel consumption of the hybrid electric vehicle powered by the battery, fuel cell, and supercapacitor (See: Munir M F, Ahmad I, Siffat S A, Qureshi M A, Armghan H, Ali N., “Non-linear control for electric power stage of fuel cell vehicles”, ISA Transactions 2020; 102: 117-134, incorporated herein by reference in its entirety).

Pulse width modulation has been employed for the regulation of a DC-bus voltage, to provide maximum acceleration and velocity (See: Fathabadi H., “Novel fuel cell/battery/supercapacitor hybrid power source for fuel cell hybrid electric vehicles”, Energy 2018; 143: 467-477, incorporated herein by reference in its entirety).

A model predictive control (MPC) of a FCHEV was introduced to calibrate the overall cost of running the vehicle while preventing the degradation of the energy sources. The MPC was utilized to improve the efficiency of the FCHEV by attenuating its speed over a finite time horizon (See: Hu X, Zou C, Tang X, Liu T, Hu L., “Cost-Optimal Energy Management of Hybrid Electric Vehicles Using Fuel Cell/Battery Health-Aware Predictive Control.”, IEEE Transactions on Power Electronics 2020; 35(1): 382-392, incorporated herein by reference in its entirety).

A conventional adaptive terminal sliding mode control for hybrid energy storage systems of a fuel cell, a battery and a supercapacitor was developed, that uses a terminal sliding mode control strategy with projection operator adaptive law in a hybrid energy storage system (HESS). However, the adaptive terminal sliding mode control exhibits chattering effects which lead to wear and tear of mechanical parts and loss of energy. (See: Dezhi Xu, Qian Liu, Wenxu Yan, and Weilin Yang., “Adaptive Terminal Sliding Mode Control for Hybrid Energy Storage Systems of Fuel Cell, Battery and Supercapacitor”, IEEE, incorporated herein by reference in its entirety).

A passivity-based control (PBC) has been described which was developed for the energy management of the FCHEV. The PBC is a nonlinear control method that guarantees the stability of a closed-loop system by keeping it passive while maintaining a storage function. The PBC requires an exact system model, which limits its practical application due to a lack of robustness, particularly for FCHEV, in which the vehicle speed is stochastic and exact system parameters are usually unavailable. (See: Ortega R, Schaft v. dA, Castanos F, Astolfi A., “Control by Interconnection and Standard Passivity-Based Control of Port-Hamiltonian Systems”, IEEE Transactions on Automatic Control 2008; 53(11): 2527-2542, incorporated herein by reference in its entirety).

Hence, there is a need for a passivity-based power distribution control system for hybrid electric vehicles that is capable of employing energy harvesting schemes, is able to supply continuous power to the load, ensures that the currents of the battery, fuel cell, and ultra-capacitor are tracking their respective reference values, and stabilizes the DC-bus voltage.

### SUMMARY

In an exemplary embodiment, a passivity-based power distribution control system for a hybrid electric vehicle is described. The system includes a proton-exchange membrane fuel cell module, a battery module, an ultra-capacitor module, and a duty cycle controller. The proton-exchange membrane fuel cell module includes a proton-exchange membrane fuel cell (PEMFC) and a PEMFC boost converter coupled to the PEMFC. The PEMFC module is configured to generate a PEMFC current I_{FC}. The battery module includes a battery and a battery buck/boost converter coupled to the rechargeable battery. The battery module is configured to generate a battery current I_{b}. The ultra-capacitor module includes an ultra-capacitor (UC) and a UC buck/boost converter coupled to the UC. The UC module is configured to generate a UC current I_{UC}. The duty cycle controller is coupled to the battery module, the proton-exchange membrane fuel cell module and the ultra-capacitor module. The duty cycle controller is configured to control a PEMFC duty cycle D₁ of the PEMFC boost converter, a battery duty cycle D₂₃ of the battery buck/boost converter, and a UC duty cycle D₄₅ of the UC buck/boost converter.

In another exemplary embodiment, a method for passivity-based power distribution control of a drive train of a hybrid electric vehicle is described. The method includes building a proton-exchange membrane fuel cell module by connecting a proton-exchange membrane fuel cell (PEMFC) to a PEMFC boost converter. The method includes building a battery module by connecting a rechargeable battery to a battery buck/boost converter. The method includes building an ultra-capacitor module by connecting an ultra-capacitor (UC) to a UC buck/boost converter. The method further includes connecting a DC bus in parallel with a capacitor C₀, wherein the DC bus has a bus voltage V₀. The method further includes connecting the PEMFC module, the battery module and the ultra-capacitor module to the DC bus. The method further includes connecting a duty cycle controller to the PEMFC boost converter, the battery buck/boost converter and the ultra-capacitor buck/boost converter. The method further includes transmitting, by the duty cycle controller, a PEMFC duty cycle D₁ to the PEMFC boost converter, a battery duty cycle D₂₃ to the battery buck/boost converter, and a UC duty cycle D₄₅ to the UC buck/boost converter. The method further includes generating a PEMFC current I_{FC} by the PEMFC module. The method further includes transmitting, by the PEMFC boost converter, the PEMFC current I_{FC} to the DC bus at a timing defined by the duty cycle D₁. The method further includes generating a battery current I_{b} by the battery module. The method further includes transmitting, by the battery buck/boost converter, the battery current I_{b} to the DC bus at a timing defined by the duty cycle D₂₃. The method further includes generating a UC current I_{UC} by the UC module. The method further includes transmitting, by the UC buck/boost converter, the UC current I_{UC} to the DC bus at a timing defined by the duty cycle D₄₅. The method further includes transmitting a DC bus load current I_{L} to the drive train of the hybrid electric vehicle.

In another exemplary embodiment, a method for passivity-based power distribution control is described. The method includes transmitting, by a duty cycle controller, a PEMFC duty cycle D₁ to a PEMFC boost converter, a battery duty cycle D₂₃ to a battery buck/boost converter, and a UC duty cycle D₄₅ to a UC buck/boost converter, wherein the PEMFC boost converter, the battery buck/boost converter, and the UC buck/boost converter are each connected in parallel with a DC bus. The method includes generating a PEMFC current I_{FC} by the PEMFC module. The method includes transmitting, by the PEMFC boost converter, the PEMFC current I_{FC} to the DC bus at a timing defined by the duty cycle D₁. The method includes generating a battery current I_{b} by the battery module. The method includes transmitting, by the battery buck/boost converter, the battery current I_{b} to the DC bus at a timing defined by the duty cycle D₂₃. The method further includes generating a UC current I_{UC} by the UC module. The method includes transmitting, by the UC buck/boost converter, the UC current I_{UC} to the DC bus at a timing defined by the duty cycle D₄₅. The method includes transmitting a DC bus load current I_{L} to a load.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a circuit diagram of a hybrid electric vehicle, according to aspects of the present disclosure;

FIG. 2 illustrates an exemplary diagram of energy management in the hybrid electric vehicle, according to aspects of the present disclosure;

FIG. 3A is a circuit diagram of a passivity-based power distribution control system for the hybrid electric vehicle, according to aspects of the present disclosure;

FIG. 3B is a block diagram of a duty cycle controller, according to aspects of the present disclosure;

FIG. 3C is a circuit diagram of a drive train of the hybrid electric vehicle, according to aspects of the present disclosure;

FIG. 4 is a graph of a driving cycle profile, according to aspects of the present disclosure;

FIG. 5 is a graph of load current requirement for different speeds of the hybrid electric vehicle, according to aspects of the present disclosure;

FIG. 6 is graph of a tracking curve of a fuel cell current supplied to a load, according to aspects of the present disclosure;

FIG. 7 illustrates a tracking curve of a battery current, according to aspects of the present disclosure;

FIG. 8 illustrates a tracking curve of an ultra-capacitor current, according to aspects of the present disclosure;

FIG. 9 is a tracking curve of a DC-bus voltage, according to aspects of the present disclosure;

FIG. 10A is a graph showing the fuel cell current under various control techniques, according to aspects of the present disclosure;

FIG. 10B is a graph showing the fuel cell current when the fuel cell current is 40 A, according to aspects of the present disclosure;

FIG. 10C is a graph showing the fuel cell current when the fuel cell current is 40 A at different times, according to aspects of the present disclosure;

FIG. 10D is a graph showing the fuel cell current when the fuel cell current is 40 A at different times, according to aspects of the present disclosure;

FIG. 10E is a graph showing the fuel cell current when the fuel cell current is 17 A, according to aspects of the present disclosure;

FIG. 11A is a graph showing the battery current under various control techniques, according to aspects of the present disclosure;

FIG. 11B is a graph showing the battery current when the battery current lies between 0-20 A, according to aspects of the present disclosure;

FIG. 11C is a graph showing the battery current when the current lies in between 0-−20 A, according to aspects of the present disclosure;

FIG. 11D is a graph showing the battery current when the current lies in between 0-20 A at different times under various control techniques, according to aspects of the present disclosure;

FIG. 11E is is a graph showing the battery current when the battery current is in between 0-−20 A at different times, according to aspects of the present disclosure;

FIG. 11F is is a graph that represents the battery current when the battery current lies in between 0-20 A at t=190 sec, according to aspects of the present disclosure;

FIG. 12A is a graph showing the ultra-capacitor current under various control techniques, according to aspects of the present disclosure;

FIG. 12B is a graph showing the ultra-capacitor current when the ultra-capacitor current lies in between 0-15 A, according to aspects of the present disclosure;

FIG. 12C is a graph showing the ultra-capacitor current when the ultra-capacitor current lies in between 0-−20 A, according to aspects of the present disclosure;

FIG. 12D is a graph showing the ultra-capacitor current when the ultra-capacitor current lies in between 0-15 A, at t=108 sec, according to aspects of the present disclosure;

FIG. 12E is a graph showing the ultra-capacitor current when the ultra-capacitor current lies in between 0-−100 A, according to aspects of the present disclosure;

FIG. 12F is a graph of the ultra-capacitor current when the ultra-capacitor current lies in between 0-100 A, according to aspects of the present disclosure;

FIG. 13 is a graph showing the DC-bus voltage curves under various control techniques, according to aspects of the present disclosure;

FIG. 14 is an illustration of a non-limiting example of details of computing hardware used in the computing system, according to aspects of the present disclosure;

FIG. 15 is an exemplary schematic diagram of a data processing system used within the computing system, according to aspects of the present disclosure;

FIG. 16 is an exemplary schematic diagram of a processor used with the computing system, according to aspects of the present disclosure; and

FIG. 17 is an illustration of a non-limiting example of distributed components that may share processing with the controller, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a passivity-based power distribution controller that includes a proton-exchange membrane fuel cell (PEMFC) for generating a PEMFC current, a PEMFC boost converter coupled to the PEMFC, a battery for generating a battery current, a battery buck/boost converter coupled to the battery, an ultra-capacitor (UC) for generating a UC current, a UC buck/boost converter coupled to the UC, and a controller coupled to the PEMFC, the battery, and the UC. The controller is configured to control a duty cycle of each converter (the PEMFC boost converter, the battery buck/boost converter, and the UC buck/boost converter). The PEMFC, the battery, and the ultra-capacitor are connected to a direct current (DC)-bus via a plurality of DC-DC power converters. The DC-bus is connected to an alternating current (AC) motor, which drives an electric vehicle via a DC-AC converter. The plurality of DC-DC power converters allows the control and energy management of the energy sources according to a power-sharing strategy to meet load requirements. The passivity-based power distribution control system is configured to deliver the required power to the load, thereby providing voltage regulation of the DC-bus, tracking reference currents for the battery, the fuel cell, and the ultra-capacitor, and ensuring the stability of the FCHEV system for any load condition.

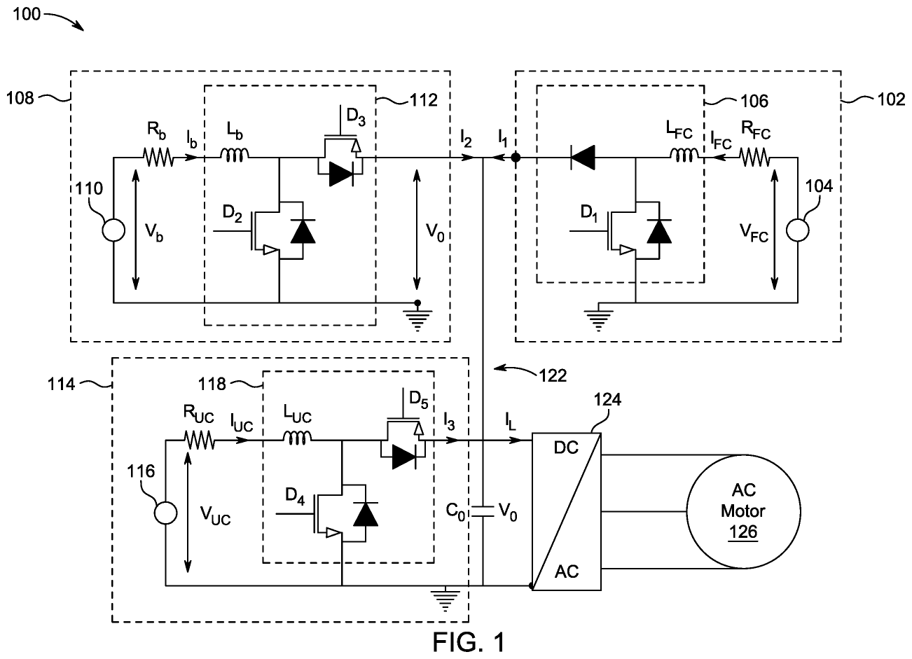

FIG. 1 is a circuit diagram of a hybrid electric vehicle (or a fuel cell hybrid electric vehicle) 100, according to aspects of the present disclosure. As shown in FIG. 1, the fuel cell hybrid electric vehicle (FCHEV) 100 includes a proton-exchange membrane fuel cell (PEMFC) module 102, a battery module 108, an ultra-capacitor module 114, a DC bus 122, a DC-AC converter 124, an AC motor 126, and a control circuit (not shown in FIG. 1).

In the FCHEV 100, the AC motor 126 is combined with a plurality of auxiliary energy sources (the PEMFC module 102, the battery module 108, and the ultra-capacitor module 114). The plurality of auxiliary energy sources forms a hybrid energy storage system to supply energy to the FCHEV 100. The FCHEV 100 employs the PEMFC module 102, the battery module 108, and the ultra-capacitor module 114 as the energy sources to provide energy to the drive train of the electric vehicle. The battery module 108 is easy to install, has low maintenance, and is low cost. The ultra-capacitor module 114 is an energy storage unit for enhancing the dynamic response of the FCHEV 100. The ultra-capacitor module 114 is used to provide load or recover energy when the load fluctuates rapidly. The plurality of auxiliary energy sources can also include additional batteries, additional ultracapacitors (UCs), superconducting magnetic energy storage (SMES) devices, solar photovoltaics (SPVs), and flywheels.

The PEMFC module 102 includes at least one proton-exchange membrane fuel cell (PEMFC) 104 and a PEMFC boost converter 106. The PEMFC boost converter 106 is coupled to the PEMFC 104. The PEMFC boost converter 106 is configured to generate an output voltage that is higher than an input voltage generated by the PEMFC 104. The PEMFC module 102 is configured to generate a PEMFC current I_{FC}.

The battery module 108 includes a rechargeable battery 110 and a battery buck/boost converter 112. The battery buck/boost converter 112 is coupled to the rechargeable battery 110. The battery buck/boost converter 112 is configured to generate a constant DC output voltage from a variable DC input voltage source. The battery module 108 is configured to generate a battery current I_{b}. For example, the rechargeable battery 110 is a lithium-ion battery or a lead-acid battery.

The ultra-capacitor module 114 includes an ultra-capacitor 116 and an ultra-capacitor (UC) buck/boost converter 118. The UC buck/boost converter 118 is coupled to the ultra-capacitor 116. The ultra-capacitor module 114 is configured to generate a UC current I_{UC}. The UC buck/boost converter 118 is configured to supply a regulated DC output from a power source delivering a voltage either below or above the regulated output voltage.

The FCHEV 100 is configured to use any number of loads or energy sources coupled to one or more DC buses. In an example, the applications include electric vehicles (EV) or hybrid vehicles (HEV, or plug-in PHEV) where both steady-state (e.g., continuous heavy power draw demand for climbing a hill) and transient (e.g., acceleration) power are required. Furthermore, in an example, an uninterruptible power supply (UPS) system can also be enhanced with the FCHEV 100 to reduce the loading on the batteries when the system rapidly provides power in the event of a power failure.

The DC bus 122 is coupled to the PEMFC boost converter 106, the battery buck/boost converter 112, the UC buck/boost converter 118, and the AC motor 126. The DC bus 122 serves to conduct current between the energy sources and a drive system. In an aspect, the drive system includes an internal combustion engine, an electric motor/generator, and a power drive. The DC bus 122 is configured to receive PEMFC current I_{FC} from the PEMFC boost converter 106 at a timing defined by the duty cycle D₁. The DC bus 122 is configured to receive the battery current I_{b} from the battery buck/boost converter at a timing defined by the duty cycle D₂₃. The DC bus 122 is configured to receive UC current I_{UC} from the UC buck/boost converter at a timing defined by the duty cycle D₄₅. The DC bus 122 is configured to transmit a DC bus load current I_{L} to the load.

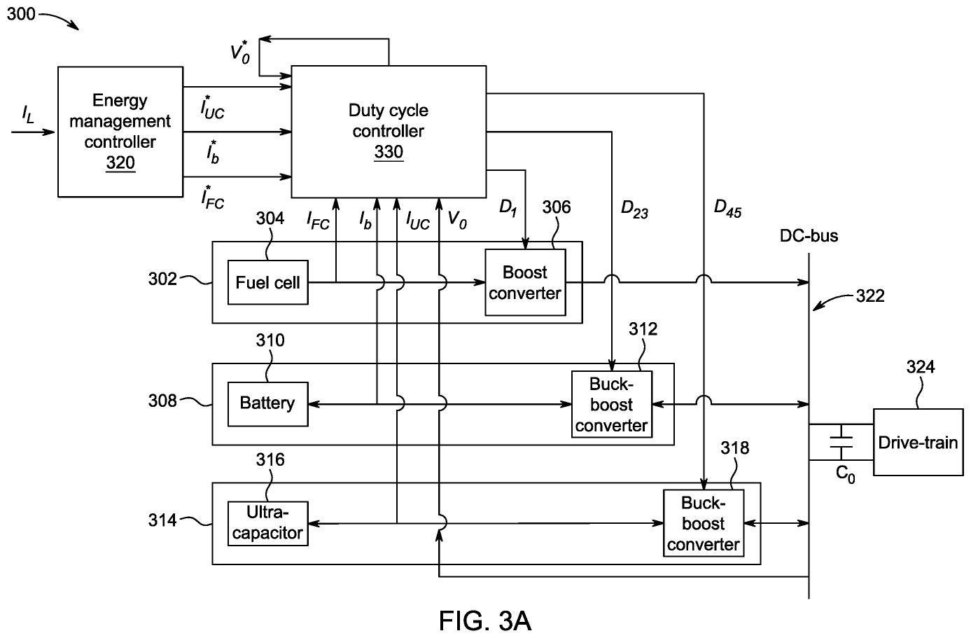

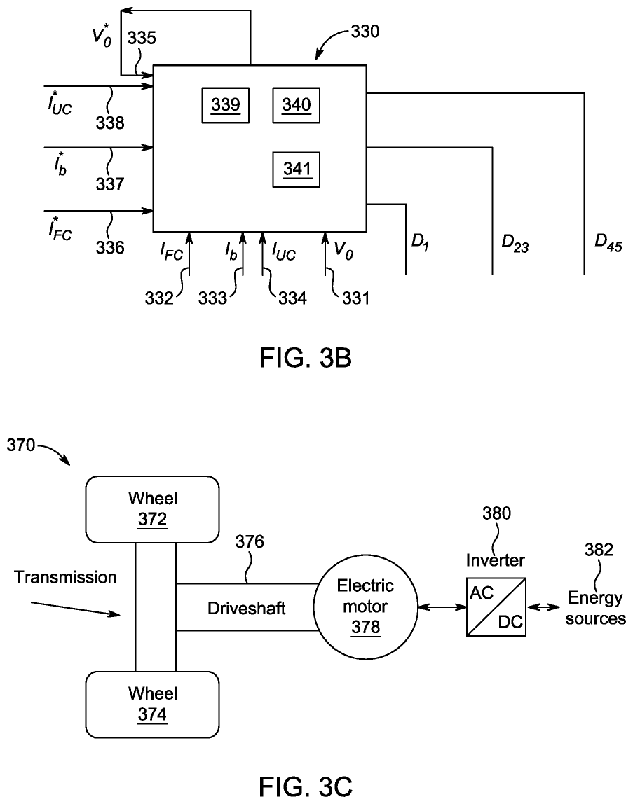

The control circuit is configured to provide an effective power sharing between the various energy sources (the PEMFC module 102, the battery module 108, and the ultra-capacitor module 114). The control circuit includes a energy management controller 320, and a duty cycle controller 330, as shown in FIG. 3A. The control circuit is configured to employ a method for passivity-based power distribution control of the drive train of the hybrid electric vehicle. The control circuit monitors the overall energy demand of the FCHEV 100 and thus regulates the functions of each of energy sources, and the AC motor to achieve defined performance. In an aspect, the PEMFC module 102, and the battery module 108 are primary energy sources, and the PEMFC module 102, and the battery module 108 operate upon different load power situations. Both the battery module 108, and the ultra-capacitor module 114 are energy support and storage devices.

The control circuit is configured to determine a charging strategy based on the energy forecast and a plurality of strategy variables and determines a control strategy for energy allocation based upon the strategy variables, energy forecast, and charging strategy. In an example, the plurality of strategy variables includes global positioning system (GPS) information, energy storage system (ESS) information, accessory information, and system default parameters. The energy is distributed to the FCHEV 100 based upon the control strategy.

In an aspect, the FCHEV 100 may be configured to operate in following modes based upon state of charge (SoC) of various energy sources:

1. Fully FCEV: In this operative mode, the FCHEV 100 only uses only the PEMFC module 102 to power a transmission system of the FCHEV 100, with no auxiliary energy source.

2. The PEMFC module 102 and the battery module 108 hybrid mode: In this operative mode. the FCHEV 100 uses PEMFC module 102 and the battery module 108 to power the transmission system of the FCHEV 100. The battery module 108 is connected to the DC bus 122 via the DC/DC converter. In this arrangement, the PEMFC module 102 is used as the main power source to supply most of the power for the load. This mode has the advantages of using recover braking energy, which is stored in the battery 110.

3. The PEMFC module 102 and the ultra-capacitor module 114 hybrid mode: In this operative mode, the FCHEV 100 uses the PEMFC module 102 and the ultra-capacitor module 114 to power the transmission system of the FCHEV 100. Compared with the disadvantages of the batteries, such as low energy density, large size, and small instantaneous charge and discharge current, the ultra-capacitor 116 has the advantages of fast charge and discharge, and of being able to be used more frequently. The ultracapacitor is connected to the DC bus through a DC/DC converter. This mode provides the advantages of efficient power recovery and better dynamic response to instantaneous high-power demand.

4. The PEMFC module 102, the battery module 108, and the ultra-capacitor module 114 hybrid mode: In this operative mode, the FCHEV 100 uses the PEMFC module 102, the battery module 108, and the ultra-capacitor module 114 to power the transmission system of the FCHEV 100. The FCHEV 100 uses the fuel cell(s) 104 as the main energy source to supply the average power demand of the load. The battery and ultracapacitor supply energy to the DC/AC converter 124 in different operating modes. Ultracapacitors can charge and discharge rapidly with high current but have small energy storage. Ultracapacitors can be used to provide instantaneous power or energy recovery when the power required by the load has sudden large changes. However, due to the complex structure of the hybrid system and the strong coupling between the power sources, the duty cycles must be tightly controlled. The battery has slower response time and is used to supplement the fuel cell energy over a longer time period.

Each of the bi-directional battery buck/boost converter 112 and the UC buck/boost converter 118 includes two insulated gate bipolar transistors (IGBTs), a high-frequency filtering inductor (Lᵢ, i=UC, b), and a filtering capacitor (C₀). The PEMFC boost converter 106 includes a high-frequency filtering inductor (L_{FC}), an IGBT, and a diode. The output currents from the boost converter (I₁) and the two buck/bust converters (I₂ and I₃) are passed to the load through the DC bus 122 and the DC-AC converter.

In aspects of the present disclosure, the control circuit is configured to employ passivity-based control (PBC) for energy management of the FCHEV. The PBC is a nonlinear control method that guarantees the stability of a closed-loop system by using a storage function. The control method is applied to the DC-DC power converters linking the energy sources to the DC-bus. The storage function is based on a passivity theory that is configured to remove all the nonlinearities of the system.

In the present disclosure, the mathematical calculations of the FCHEV are described. Next, a stored energy function based on a passivity theory is described for the stability and control of the FCHEV. An auxiliary input, including an energy-shaping term and a fractional-order proportional-derivative sliding mode surface, is added to the control circuit to accelerate convergence and improve the robustness of the closed-loop FCHEV system. The auxiliary input is configured to supply continuous power to the load, and ensures that the currents of the battery 110, the fuel cell 104, and the ultra-capacitor 116 are tracking to their respective reference values, and stabilizing the DC-bus voltage. The reference currents of the battery, fuel cell, and ultra-capacitor are obtained from an energy management controller (320, FIG. 3A, also referred to as the control circuit).

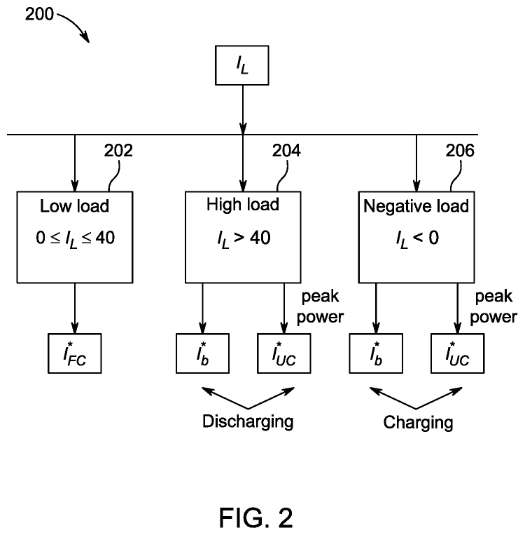

FIG. 2 illustrates an exemplary diagram 200 of energy management in the FCHEV 100, according to aspects of the present disclosure. In an aspect, the control circuit is configured to determine a load current (I_{L}) drawn by the load. Based on the determined load current (I_{L}), the control circuit is configured to classify the load requirement into three (3) categories: a) a low load category, b) a high load category, and c) a negative load category.

Power allocation management is provided by the energy management controller 302 utilizing the performance attributes of the battery module 108, the PEMFC module 102, and the ultra-capacitor module 114. In a low load category (indicated by reference 202), a value of the load current (I_{L}) lies between 0 to 40 A. In a situation in which the load demand is low, the PEMFC module 102 supplies the required current to the AC motor 126. In a high load category (indicated by reference 204), a value of the load current (I_{L}) is greater than 40 A. In this situation in which the load demand is high, the PEMFC module 102 cannot be used in order to avoid faults or fuel starvation, therefore the battery module 108 discharges to meet the high load demand. The ultra-capacitor module 114 supplies the load during a transient state, or fast peak power, which both the battery module 108 and the PEMFC module 102 cannot provide due to their high power density. In a negative load category (indicated by reference 206), a value of the load current (I_{L}) is less than 0. When the load power is negative, the PEMFC module 102 does not operate, and the battery module 108 and the ultra-capacitor module 114 charge by recovering regenerative braking energy. Therefore, both the rechargeable battery 110 and the ultra-capacitor 116 are charging. The power allocation can be accomplished as:

$${P}_{F C}^{*} + {P}_{b}^{*} + {P}_{U C}^{*} = {P}_{L} , \qquad ( 1 )$$

where P*_{b} and P*_{FC} are the battery reference power and the fuel cell reference power, respectively, which are apportioned in the power allocation, and PUC is the ultra-capacitor reference power derived from the remaining load demand, which includes the energy generated by regenerative braking and fast peak power. Thus, the reference currents of the battery 110, the fuel cell 104, and the ultra-capacitor 116 can be derived by sharing the load current accordingly. For energy management of the FCHEV 100, the following considerations should be incorporated during modelling, training and programming the energy management controller 320.

1 The fuel cell current must be positive and cannot exceed a defined limit (40 A) to lessen stack degradations and faults. The reference fuel cell current is calculated using a low pass filter as:

$${I}_{FC}^{*} = \{ \begin{matrix}0 & if \frac{2 π {f}_{FC}}{2 π {f}_{FC} + s} {I}_{L} \leq 0 \\ \frac{2 π {f}_{FC}}{2 π {f}_{FC} + s} {I}_{L} & if \frac{2 π {f}_{FC}}{2 π {f}_{FC} + s} {I}_{L} > 0 \\ 40 & if \frac{2 π {f}_{FC}}{2 π {f}_{FC} + s} {I}_{L} > 40\end{matrix} , \qquad ( 2 )$$

where I*_{FC} is the fuel cell reference current, and f_{FC} is a low-pass filter cut-off frequency of the fuel cell reference current.

2 The battery reference current is calculated using the low pass filter as follows:

$${I}_{b}^{*} = \{ \begin{matrix}20 & if \frac{2 π {f}_{b}}{2 π {f}_{b} + s} ( {I}_{L} - {I}_{FC}^{*} ) > 20 \\ \frac{2 π {f}_{b}}{2 π {f}_{b} + s} ( {I}_{L} - {I}_{FC}^{*} ) & if - 20 \leq \frac{2 π {f}_{b}}{2 π {f}_{b} + s} ( {I}_{L} - {I}_{FC}^{*} ) \leq 20 \\ - 20 & if \frac{2 π {f}_{b}}{2 π {f}_{b} + s} ( {I}_{L} - {I}_{FC}^{*} ) < - 20\end{matrix} ; \qquad ( 3 )$$

where I*_{b} is the reference current, and f_{b} is the low-pass filter cut-off frequency of the battery reference current. To prolong the life cycle of the battery 110, the battery 110 is constrained to prevent discharging more than 20 A or charging beyond −20 A.

3 The ultra-capacitor 116 recovers the fast peak power during regenerative braking, and discharges the fast peak power to support the load during the high load demand. The reference ultra-capacitor current is calculated as follows:

$${I}_{U C}^{*} = {I}_{L} - {I}_{F C}^{*} - {I}_{b}^{*} . \qquad ( 4 )$$

FIG. 3A illustrates an exemplary diagram of a passivity-based power distribution control system 300 for the FCHEV 100, according to aspects of the present disclosure. Referring to FIG. 3A, the passivity-based power distribution control system 300 includes a proton-exchange membrane fuel cell module 302, a battery module 308, an ultra-capacitor module 314, an energy management controller 320, a DC bus 322, a drive train 324, and a duty cycle controller 330.

The proton-exchange membrane fuel cell module 302 includes a proton-exchange membrane fuel cell (PEMFC) 304, and a PEMFC boost converter 306. The PEMFC boost converter 306 is coupled to the PEMFC 304. The PEMFC module 302 is configured to generate the PEMFC current I_{FC}.

The battery module 308 includes a rechargeable battery 310 and a battery buck/boost converter 312. The battery buck/boost converter 312 is coupled to the rechargeable battery 310. The battery module 308 is configured to generate the battery current I_{b}.

The ultra-capacitor module 314 includes an ultra-capacitor (UC) 316 and a UC buck/boost converter 318. The UC buck/boost converter 318 is coupled to the UC 316. The ultra-capacitor module 314 is configured to generate the UC current I_{UC}.

The duty cycle controller 330 is coupled to the battery module 308, the proton-exchange membrane fuel cell module 302, and the ultra-capacitor module 314. The duty cycle controller 330 is configured to control a PEMFC duty cycle D₁ of the PEMFC boost converter 306, a battery duty cycle D₂₃ of the battery buck/boost converter 312, and a UC duty cycle D₄₅ of the UC buck/boost converter 318.

The bus capacitor C₀ is connected in parallel with the DC bus 122, 322. The DC bus 322 is connected to the PEMFC boost converter 306, the battery buck/boost converter 312 and the UC buck/boost converter 318. The energy sources (the proton-exchange membrane fuel cell module 302, the battery module 308, and the ultra-capacitor module 314) are connected to the DC bus 322 through the power converters. The outputs of the energy sources are controlled by manipulating the duty-cycles (D₁, D₂₃ and D₄₅) of the power converters. The PEMFC boost converter 306, the battery buck/boost converter 312, and the UC buck/boost converter 318 are configured to receive the PEMFC duty cycle D₁, the battery duty cycle D₂₃, and the UC duty cycle D₄₅, respectively, and transmit the PEMFC current I_{FC}, the battery current I_{b} and the UC current I_{UC} respectively to the DC bus 322. The DC bus 322 has a bus voltage V₀ formed across the bus capacitor C₀ by the PEMFC current I_{FC}, the battery current I_{b}, and the UC current I_{UC}. The DC bus 322 is configured to transmit a DC bus load current I_{L} to the drive train 324 of the hybrid electric vehicle. The drive train 324 of the hybrid electric vehicle is responsible for delivering power from the energy source (for example, the battery 310) to the wheels of the hybrid electric vehicle. The drive train 324 is the unit of the electric vehicle that converts electrical energy to mechanical energy delivered to the wheels. The drive train 324 is made up of several different moving parts, that is, three main components: the electric motor, drive shafts, and transmission.

The energy management controller 320 is connected to the DC bus 322. The energy management controller 320 is configured to receive the DC bus load current I_{L} and generate a reference PEMFC current I_{FC}*, a reference battery current I_{b}* and a reference UC current I_{UC}*. The energy management controller 320 is configured to analyze the current demand I_{L} for the drive train 324. The energy management controller 320 coordinates the power balance between the energy sources and the drive train 324 in all driving conditions. In addition, the energy management controller 320 splits I_{L} among the energy sources considering their power characteristics.

The duty cycle controller 330 ensures that the energy sources are operating according to the current allocated to each of them by the energy management controller 320. Also, the duty cycle controller 330 neutralizes negative impacts of dynamic uncertainties and external disturbances. Furthermore, the duty cycle controller 330 guarantees the stability of the DC-bus voltage, the energy sources, and the overall system in all driving conditions.

In an aspect, the fuel cell current must be positive and cannot exceed a certain limit to lessen stack degradations and faults. The reference fuel cell current I*_{{FC}} is computed by the energy management controller 320 using a low-pass filter (not shown). The low-pass filter removes the high-frequency part of the drive train's current demand. Then, the reference fuel cell current I*_{FC} is transferred to the duty cycle controller 330 to ensure that the PEMFC module 302 supplies the required current. The duty cycle controller 330 then transmits the duty-cycle signal D₁ to the PEMFC boost converter 306 which allows the transfer of the reference fuel cell current I*_{FC} to the drive train 324.

Since the PEMFC 304 cannot store the regenerative energy or supply power beyond a certain limit, the rechargeable battery 310 is configured to store energy. To prolong the life cycle of the rechargeable battery 310, the charging-discharging operation is constrained by the energy management controller 320. The energy management controller 320 is configured to compute the reference battery current IR. The duty cycle controller 330 facilitates the supply of current I_{b}=I*_{b} by sending the duty-cycle signal D₂₃ to the battery buck/boost converter 312.

The ultra-capacitor module 314 is configured to store or supply the required peak/transient reference UC current I*_{UC} which both the PEMFC module 302 and the battery module 308 are unable to handle. The reference UC current I*_{UC} is computed in the energy management controller 320 and then sent to the duty cycle controller 330 to ensure that the ultra-capacitor (UC) 316 is charging/charging accordingly, to maintain the power balance and prevent degradation of the energy system. The duty cycle controller 330 then transmits the duty-cycle D₄₅ to the UC buck/boost converter 318 which allows bi-directional flow of power between the drive train 324 and the PEMFC 304.

FIG. 3B is a block diagram of the duty cycle controller 330, according to aspects of the present disclosure. As shown in FIG. 3B, the duty cycle controller includes a DC bus connection port 331, a first input port 332, a second input port 333, a third input port 334, a first reference input port 335, a second reference input port 336, a third reference input port 337, and a fourth reference input port 338. The DC bus connection port 331 is configured to receive the bus voltage V₀. The first input port 332 is configured to receive the PEMFC current I_{FC}. The second input port 333 is configured to receive the battery current I_{b}. The third input port 334 is configured to receive the UC current I_{UC}. The first reference input port 335 is configured to receive a reference bus voltage V₀*. The reference input port is configured to receive the reference PEMFC current I_{FC}*. The third reference input port 337 is configured to receive the reference battery current I_{b}*. The fourth reference input port 338 is configured to receive the reference UC current I_{UC}*.

The duty cycle controller 330 further includes a circuitry 339, a memory 340, and at least one processor 341. The memory 340 is configured to store program instructions and the reference PEMFC current I_{FC}*, the reference battery current I_{b}*, the reference UC current I_{UC}*, and the reference bus voltage V₀*. In an example, the memory 340 is a random access memory (“RAM”) for temporary storage of information and/or a read only memory (“ROM”) for permanent storage of information, and a mass storage device, such as a hard drive, diskette, or optical media storage device. In an aspect, the circuitry 339 is configured to employ preprocessing on the data (signal), such as filtering and amplifying the data. The at least one processor is configured to cooperate with the memory to fetch and execute computer-readable program instructions stored in the memory. According to an aspect of the present disclosure, the at least one processor 341 may be implemented as one or more microcomputers, microcontrollers, digital signal processors, central processing units, state machines, logic circuitries, and/or any devices that manipulate signals based on operational instructions.

Under the program instructions, the duty cycle controller 330 is configured to subtract the reference voltage V₀* from the bus voltage V₀. The duty cycle controller 330 subtracts the reference PEMFC current I_{FC}* from the PEMFC current I_{FC}, and generates the PEMFC duty cycle D₁. Also, the duty cycle controller 330 subtracts the reference battery current I_{b}* from the battery current I_{b}, and generates the battery duty cycle D₂₃. The duty cycle controller 330 subtracts the reference UC current, I_{UC}* from the UC current I_{UC} and generates the UC duty cycle D₄₅. The duty cycle controller 330 transmits the PEMFC duty cycle D₁, the battery duty cycle D₂₃ and the UC duty cycle D₄₅, to the PEMFC boost converter 306, the battery buck/boost converter 312 and the UC buck/boost converter 318, respectively.

Under the program instructions, the duty cycle controller 330 is configured to determine a set of tracking error variables. The duty cycle controller 330 relates the tracking error variables to the duty cycles D₁, D₂₃ and D₄₅ and formulates a stored energy function consisting of the sum of a resistive heat produced by the currents I_{FC}, I_{b} and I_{UC} flowing through the PEMFC, the battery, the ultra-capacitor and the DC bus. The duty cycle controller 330 calculates a time derivative of the stored energy function.

The duty cycle controller 330 is further configured to formulate a first equation which defines the PEMFC duty cycle D₁ in terms of each component of the PEMFC current I_{FC} in the PEMFC module 302 minus the reference PEMFC current I_{FC}* minus an auxiliary term v₁. The duty cycle controller 330 is configured to formulate a second equation which defines the battery duty cycle D₂₃ in terms of each component of the battery current I_{FC} in the battery module 308 minus the reference battery current I_{b}* minus an auxiliary term v₂. The duty cycle controller 330 is configured to formulate a third equation which defines the UC duty cycle D₄₅ in terms of each component of the UC current I_{UC} in the UC module 314 minus the reference UC current I_{UC}* minus an auxiliary term v₃. The duty cycle controller 330 formulates a fourth equation which defines the reference bus voltage V₀* in terms of a voltage component of the bus voltage which includes a sum of a PEMFC voltage generated across the bus capacitor C₀ by the PEMFC current I_{FC}, a battery voltage generated across the bus capacitor C₀ by the battery current I_{b}, a UC voltage generated across the bus capacitor C₀ by the UC current I_{UC}, an auxiliary term v₄, minus a load voltage generated across the bus capacitor by the load current I_{L}.

The duty cycle controller 330 is configured to substitute the first equation, the second equation, the third equation and the fourth equation into the derivative of the stored energy function to formulate the stored energy equation in terms of the auxiliary terms v₁, v₂, v₃ and v₄.

The duty cycle controller 330 is further configured to formulate a set of fractional order sliding mode surfaces from the derivative of the stored energy function. The duty cycle controller 330 redefines the auxiliary terms v₁, v₂, v₃ and v₄ by the set of fractional order sliding mode surfaces, respectively, wherein each redefined auxiliary term v₁, v₂, v₃ and v₄ includes an energy shaping term and a robust term which includes hyperbolic tangent of a respective sliding mode surface.

The duty cycle controller 330 is configured to substitute the redefined auxiliary terms into the stored energy equation. The duty cycle controller 330 bounds the stored energy equation by an equation formulated to include a weighted sum of a squared value of each tracking error minus an absolute value of each tracking error, wherein the bounded stored energy equation is configured to force the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

FIG. 3C is a circuit diagram of the drive train 370 of the electric vehicle, according to aspects of the present disclosure. The drive train 370 of the electric vehicle transfer power from the power sources to wheels (372, 374). In order words, it is responsible for moving the vehicle. As shown in FIG. 3C, the main components of the drive train 370 include two wheels (372, 374), a driveshaft 376, an electric motor 378, an AC-DC converter (inverter 380), and a plurality of energy sources 382.

The electric motor 378 is configured to convert the electric power from the energy sources 382 into mechanical power/torque. A transmission system is configured to regulate the speed of the motor to maintain a defined performance, and the driveshaft 376 utilizes the mechanical torque developed by the motor to set the wheels in motion.

The speed of the vehicle wheels vₛ is expressed in terms of the propulsion force and the frictional forces opposing the motion of the vehicle as follows:

$$M \frac{d {v}_{s}}{d C} = {T}_{p} - 0.5 {ρ}_{a} A {C}_{x} {v}_{s}^{2} - M g {C}_{r} , \qquad ( 5 )$$

where M is the total mass of the vehicle, and Tₚ is the mechanical/propulsion force developed by the motor that the driveshaft 376 utilizes to set the wheels in motion. It is desired that the motor produces enough Tₚ to overcome the opposing/frictional forces (−0.5ρₐACₓvₛ²−MgCᵣ_{ₚ}).

The propulsion power Pₚ required by the motor to produce Tₚ is computed as follows:

$${P}_{p} = {T}_{p} vs , \qquad ( 6 )$$

which becomes

$${P}_{p} = [ M \frac{d {v}_{s}}{d t} + 0.5 {ρ}_{a} A {C}_{x} {v}_{s}^{2} + M g {C}_{r} ] {v}_{s} . \qquad ( 7 )$$

The DC power from the energy sources that is transferred to the inverter is calculated as follows:

$${P}_{L} = η {I}_{L} {V}_{0} , \qquad ( 8 )$$

where η is the efficiency of the inverter. The inverter transfers an AC power which corresponds to the Pₚ of the motor. The I_{L}V₀ is given by:

$${I}_{L} {V}_{0} = \frac{1}{η} {P}_{p} . \qquad ( 9 )$$

Therefore, the DC current from the energy sources that is required by the drive train 370 of the electric vehicle during the driving cycle is calculated as follows:

$${I}_{L} = \frac{1}{η {V}_{0}} [ M \frac{d {v}_{s}}{d t} + 0.5 {ρ}_{a} A {C}_{x} {v}_{s}^{2} + M g {C}_{r} ] {v}_{s} . \qquad ( 10 )$$

In an aspect, the present disclosure describes modelling of the system 300. For modeling the system 300, the following preliminaries and the passivity theory were considered.

### 1. Passivity Theory:

Consider the following a general form nonlinear system:

$$\{ \begin{matrix}\dot{χ} = f ( χ , u ) \\ y = h ( χ )\end{matrix} , \qquad ( 11 )$$

where χϵ [symbol] is a state vector, yϵ [symbol] and uϵ [symbol] are the output and input vectors, respectively. The total energy stored is given as:

$$H ( χ ) = {χ}^{T} Q χ \geq 0 , \qquad ( 12 )$$

where H(χ) is a semi-definite positive function, Qϵ [symbol] is a positive definite diagonal matrix. The stored energy function satisfies an energy-balance equation, described as:

$${\underbrace{H ( χ ) - H ( 0 )}}_{stored energy} = {\underbrace{{\int }_{0}^{t} {u}^{T} ( τ ) y ( τ ) d τ}}_{supplied energy} - {\underbrace{d ( t )}}_{dissipated energy} , \qquad ( 13 )$$

where d is a nonnegative function that represents the dissipation effects due to friction, resistance, e.t.c in practical systems. The energy-balance equation above is said to be strictly output passive if H(χ) is continuously differentiable and satisfies the following inequality equation:

$${u}^{T} y \geq \frac{\partial H ( χ )}{\partial χ} f ( χ , u ) + ξ {y}^{T} y , where ζ > 0. \qquad ( 14 )$$

### 2. From Non-Integer Calculus:

The general definition of a non-integer differentiation and integration denoted by ₐ [symbol] is:

$${}_{a} {𝒟}_{t}^{γ} = \{ \begin{matrix}\frac{{d}^{γ}}{{dt}^{γ}} & γ > 0 \\ 1 & γ = 0 \\ {\int }_{a}^{t} {( d τ )}^{γ} & γ < 0\end{matrix} . \qquad ( 15 )$$

The Riemann-Liouville definition (fractional integral of a function) of non-integer calculus is given by:

$${}_{a} {𝒟}_{t}^{γ} = {( \frac{d}{dt} )}^{m} \frac{1}{Γ ( m - γ )} {\int }_{a}^{t} \frac{f ( τ )}{{( t - τ )}^{γ - m + 1}} , \qquad ( 16 )$$

where m is the next integer greater than y such that m−1<γ<m, mϵ [symbol] , γϵ [symbol] and Γ(.) is a [symbol] gamma function.
3. System Modelling (PEMFC modelling):

By applying Kirchhoff's voltage law to the circuit of the fuel cell (PEMFC) 304, the mathematical model can be obtained as:

$${L}_{F C} \frac{{dI}_{F C}}{dt} = {V}_{F C} - {R}_{F C} {I}_{F C} - ( 1 - {D}_{1} ) {V}_{0} , \qquad ( 17 )$$

$${I}_{1} = ( 1 - {D}_{1} ) {I}_{F C} , \qquad ( 18 )$$

where I_{FC} and R_{FC} are PEMFC current and resistance, respectively, D₁ is the duty cycle of the IGBT (the PEMFC boost converter 306), which varies between 0 and 1, and V₀ is the DC-bus voltage.

The hydrogen consumption rate of the fuel cell is related to its output current as follows:

$${m}_{{H}_{2}} = \frac{{M}_{{H}_{2}}}{2 F} {I}_{F C} , \qquad ( 19 )$$

where m_{H}_{₂} is the hydrogen flow rates, I_{FC} is the PEMFC output current generated from the oxidation reaction between hydrogen and oxygen, M_{H}_{₂} is the hydrogen molar mass, and F is the Faraday constant. The PEMFC output voltage can be expressed as:

$${V}_{F C} = {E}_{F C} - {V}_{act} - {V}_{c o n c} - {V}_{o h m} , \qquad ( 20 )$$

$$\{ \begin{matrix}{E}_{FC} = 1.044 \times {10}^{- 4} ( {T}_{FC} - 298.15 ) + \\ 4.385 \times {10}^{- 5} {T}_{FC} ln ( {P}_{{H}_{2}} ) + 0.5 ln ( {P}_{{O}_{2}} ) \\ {V}_{act} = {l}_{1} + {l}_{2} {T}_{FC} + {l}_{3} {T}_{FC} ln ( {C}_{{O}_{2}} ) + {l}_{4} ln ( {I}_{FC} ) \\ {V}_{conc} = - b ln ( 1 - \frac{{I}_{FC}}{{I}_{maxi}} ) \\ {V}_{ohm} = {I}_{FC} ( {R}_{mr} + {R}_{pr} )\end{matrix} , \qquad ( 21 )$$

where E_{FC} is the open circuit voltage, T_{FC} is the PEMFC temperature, P_{H}_{₂} and P_{O}_{₂} are the partial pressures of hydrogen and oxygen, respectively, tᵢ(i=1,2,3,4) are parameters for the overvoltage at the electrodes, Rₘᵣ and Rₚᵣ are the PEMFC and proton resistances, respectively, V_{act} is the activation voltage drop, V_{conc} is the concentration voltage drop, Vₒₕₘ is the concentration voltage drop.

### 4. Battery Energy Storage Modelling:

The lithium-ion battery pack 310 is connected to the DC bus 322 through the bidirectional buck-boost converter (battery buck/boost converter 312). It operates as a buck converter during charging and as a boost converter during the discharging process. A variable Bb is defined as follows:

$${B}_{b} = \{ \begin{matrix}0 , & if {I}_{b}^{*} < 0 & ( buck ) \\ 1 , & if {I}_{b}^{*} > 0 & ( boost )\end{matrix} , \qquad ( 22 )$$

where I*_{b} denotes the reference battery current.

Mathematically, the converter dynamics during the charging (buck) mode of the battery is formulated as:

$${L}_{b} \frac{{dI}_{b}}{dt} = {V}_{b} - {I}_{b} {R}_{b} - ( 1 - {D}_{2} ) {V}_{0} , \qquad ( 23 )$$

$${I}_{2} = ( 1 - {D}_{2} ) {I}_{b} , \qquad ( 24 )$$

where I_{b} is the battery current, R_{b} is the internal resistance, V_{b} is the open-circuit voltage of the battery, D₂ is the duty cycle of the battery during the charging mode, and V₀ is the DC-bus voltage.

Similarly, converter dynamics during the discharging (boost) mode of the battery are expressed as:

$${L}_{b} \frac{{dI}_{b}}{dt} = {V}_{b} - {I}_{b} {R}_{b} - {D}_{3} {V}_{0} , \qquad ( 25 )$$

$${I}_{2} = {D}_{3} {I}_{b} , \qquad ( 26 )$$

where D₃ is the duty cycle of the battery during the discharging mode. Accordingly, a constraint can be made to reduce the complexity of the battery model to achieve a general formulation using a virtual control, as given in equation (27). Hence, the overall generalization of the battery model is given by:

$${D}_{23} = [ {B}_{b} ( 1 - {D}_{2} ) + ( 1 - {B}_{b} ) {D}_{3} ] , \qquad ( 27 )$$

$${L}_{b} \frac{{dI}_{b}}{dt} = {V}_{b} - {I}_{b} {R}_{b} - {D}_{23} {V}_{0} , \qquad ( 28 )$$

$${V}_{b} = {V}_{0} - \frac{{Q}_{b}}{{Q}_{b} - \int {I}_{b} dt} + {A}_{1} exp ( \begin{matrix}{A}_{2} \int & {I}_{b} d t\end{matrix} ) , \qquad ( 29 )$$

$${I}_{2} = {D}_{23} {I}_{b} , \qquad ( 30 )$$

where V₀ is the initial voltage of the battery, Q_{b} is the rated capacity of the battery, A₁ and A₂ are battery constants.

### 5. Ultra-Capacitor Modelling:

The ultra-capacitor allows both charging and discharging which requires the flow of current in both directions. The ultra-capacitor can be charged via regenerative braking and by utilizing the peak power from the battery. Therefore, a bi-directional buck/boost converter is used, and its mode of operation is the same as that of the battery. A variable BUC is defined as follows:

$${B}_{UC} = \{ \begin{matrix}0 , & if {I}_{UC}^{*} < 0 & ( buck ) \\ 1 , & if {I}_{UC}^{*} > 0 & ( boost )\end{matrix} , \qquad ( 31 )$$

where I*_{UC} represents the reference ultra-capacitor current. The mathematical equation of the converter during the discharging (boost) mode of the ultra-capacitor is calculated as:

$${L}_{U C} \frac{{dI}_{U C}}{dt} = {V}_{U C} - {I}_{U C} {R}_{U C} - ( 1 - {D}_{4} ) {V}_{0} , \qquad ( 32 )$$

$${I}_{3} = ( 1 - {D}_{4} ) {I}_{U C} , \qquad ( 33 )$$

where I_{UC} is the ultra-capacitor current, R_{UC} is the internal resistance of the ultra-capacitor, and D₃ is the generated control signal during the charging mode of the ultra-capacitor.

In the charging phase, the converter equations are given by:

$${L}_{U C} \frac{{dI}_{U C}}{dt} = {V}_{U C} - {I}_{U C} {R}_{U C} - {D}_{5} {V}_{0} , \qquad ( 34 )$$

$${I}_{3} = {D}_{5} {I}_{U C} , \qquad ( 35 )$$

The virtual control is given by:

$${D}_{45} = [ {B}_{U C} ( 1 - {D}_{4} ) + ( 1 - {B}_{U C} ) {D}_{5} ] , \qquad ( 36 )$$

By combining the Equations (32) and (34), the ultra-capacitor converter equation can be expressed as follows:

$${L}_{UC} \frac{{dI}_{UC}}{dt} = {V}_{UC} - {I}_{UC} {R}_{UC} - {D}_{45} {V}_{0} , \qquad ( 37 )$$

$${V}_{UC} = {V}_{{UC}_{0}} {e}^{- ( \frac{t}{{R}_{UC} {C}_{UC}} )} , \qquad ( 38 )$$

$${I}_{3} = {D}_{45} {I}_{UC} , \qquad ( 39 )$$

where V_{UC} and V_{UC}_{₀} are the voltage level and initial voltage of the ultra-capacitor. The quantity of energy drawn from the ultra-capacitor is represented by the following equation.

$${E}_{UC} = \frac{{C}_{UC} ( {V}_{{UC}^{-}}^{2} {V}_{{UC}_{0}}^{2} )}{2} , \qquad ( 40 )$$

where E_{UC} is the quantity of energy drawn from the ultra-capacitor, and C_{UC} is the capacitance of the ultra-capacitor.

### 6. Global System Modelling:

Applying the Kirchhoff's current law, the following equations are formulated:

$${C}_{0} \frac{{dV}_{0}}{dt} + {I}_{L} = {I}_{1} + {I}_{2} + {I}_{3} . \qquad ( 41 )$$

$${C}_{0} \frac{{dV}_{0}}{dt} = ( 1 - {D}_{1} ) {I}_{FC} + {D}_{23} {I}_{b} + {D}_{45} {I}_{UC} - {I}_{L} . \qquad ( 42 )$$

### 7. Electric Drive Train Modelling:

The power required by the electric drive train should be computed first in order to design a proper power supply unit. The power depends on acceleration, mass of the vehicle, maximum speed, and so on. Assuming that the inverter efficiency is 80%, the power required by the electric drive train is given by:

$${P}_{L} = \frac{1}{0.8} [ M \frac{{dv}_{s}}{dt} + 0.5 {ρ}_{a} {AC}_{x} {v}_{s}^{2} + {MgC}_{r} ] {v}_{s} , \qquad ( 43 )$$

where vₛ is the vehicle speed, Cᵣ is the rolling resistance coefficient, Cₓ is the aerodynamic drag coefficient, g is the acceleration due to gravity, M is the vehicle mass, A is the vehicle frontal surface, and ρₐ is the density of air.

Assuming that the DC-bus voltage remains constant throughout the operation, then the current drawn by the electric drive train is calculated as follows:

$${I}_{L} = \frac{1}{0.8 {V}_{0}} [ M \frac{{dv}_{s}}{dt} + 0.5 {ρ}_{a} {AC}_{x} {v}_{s}^{2} + {MgC}_{r} ] {v}_{s} . \qquad ( 44 )$$

Using the Equations (17), (28), (37), and (42), the overall mathematical equations of the FCHEV 100 is given by:

$$\frac{{dI}_{FC}}{dt} = \frac{{V}_{FC}}{{L}_{FC}} - \frac{{R}_{FC}}{{L}_{FC}} {I}_{FC} - \frac{( 1 - {D}_{1} )}{{L}_{FC}} {V}_{0} , \qquad ( 45 )$$

$$\frac{{dI}_{b}}{dt} = \frac{{E}_{b}}{{L}_{b}} - \frac{{R}_{b}}{{L}_{b}} {I}_{b} - \frac{{D}_{23}}{{L}_{b}} {V}_{0} , \qquad ( 46 )$$

$$\frac{{dI}_{UC}}{dt} = \frac{{V}_{UC}}{{L}_{UC}} - \frac{{R}_{UC}}{{L}_{UC}} {I}_{UC} - \frac{{D}_{45}}{{L}_{UC}} {V}_{0} , \qquad ( 47 )$$

$$\frac{{d V}_{0}}{dt} = \frac{( 1 - {D}_{1} )}{{C}_{0}} {I}_{FC} + \frac{{D}_{23}}{{C}_{0}} {I}_{b} + \frac{{D}_{45}}{{C}_{0}} {I}_{UC} - \frac{1}{{C}_{0}} {I}_{L} . \qquad ( 48 )$$

From the system Equations (45)-(48), it is obvious that the model of the FCHEV 100 is nonlinear multi-input-multi-output (MIMO), so it is essential to design an appropriate control method. By controlling D₁, D₂₃, and D₄₅, the system Equations (45)-(48) can effectively operate, I_{FC}, I_{b}>I_{UC}, and V₀ can meet the load demand. Moreover, pulse-width modulation signals (PWMS) can be sent to the FCHEV by the duty cycle controller 330.

### 8. Control Strategy:

The controlled variables are taken as I_{b}, I_{FC}, I_{UC}, and V₀ to guarantee the effective operation of the battery, the fuel cell, and the ultra-capacitor according to the power allocation. The procedure for designing the duty cycle controller 330 of the passivity-based power distribution control system 300 is given as follows:

Define the tracking error variables z₁, z₂, z₃, and z₄ as:

$${z}_{1} = {I}_{FC} - {I}_{FC}^{*} , \qquad ( 49 )$$

$${z}_{2} = {I}_{b} - {I}_{b}^{*} , \qquad ( 50 )$$

$${z}_{3} = {I}_{UC} - {I}_{UC}^{*} , \qquad ( 51 )$$

$${z}_{4} = {V}_{0} - {V}_{0}^{*} , \qquad ( 52 )$$

where V*₀ stands for the reference DC-bus voltage. Then, the relationship between the control signals and the tracking errors can be described by:

$${\dot{z}}_{1} = \frac{{V}_{FC}}{{L}_{FC}} - \frac{{R}_{FC}}{{L}_{FC}} {I}_{FC} - \frac{( 1 - {D}_{1} )}{{L}_{FC}} {V}_{0} - {i}_{FC}^{*} , \qquad ( 53 )$$

$${\dot{z}}_{2} = \frac{{E}_{b}}{{L}_{b}} - \frac{{R}_{b}}{{L}_{b}} {I}_{b} - \frac{{D}_{23}}{{L}_{b}} {V}_{0} - {i}_{b}^{*} , \qquad ( 54 )$$

$${\dot{z}}_{3} = \frac{{V}_{UC}}{{L}_{UC}} - \frac{{R}_{UC}}{{L}_{UC}} {I}_{UC} - \frac{{D}_{45}}{{L}_{UC}} {V}_{0} - {i}_{UC}^{*} , \qquad ( 55 )$$

$${\dot{z}}_{4} = \frac{( 1 - {D}_{1} )}{{C}_{0}} {I}_{FC} + \frac{{D}_{23}}{{C}_{0}} {I}_{b} + \frac{{D}_{45}}{{C}_{0}} {I}_{UC} - \frac{1}{{C}_{0}} {I}_{L} - {\dot{V}}_{0}^{*} , \qquad ( 56 )$$

A storage function is constructed for Equations (54)-(55) as follows:

$$( 57 )$$

$$H ( {I}_{b} , {I}_{FC} , {I}_{UC} , {V}_{0} ) = {\underbrace{\frac{{r}_{b}}{2} {( {I}_{b} - {I}_{b}^{*} )}^{2}}}_{battery heat} + {\underbrace{\frac{{r}_{FC}}{2} {( {I}_{FC} - {I}_{FC}^{*} )}^{2}}}_{fuel cell heat} + {\underbrace{\frac{{r}_{UC}}{2} {( {I}_{UC} - {I}_{UC}^{*} )}^{2}}}_{ultra - capacitor heat}$$

where H(I_{b}, I_{FC}, I_{UC}, V₀) is the stored energy function consisting of the sum of resistor heat produced by currents flowing through the battery, fuel cell, ultra-capacitor, and DC-bus, r_{b}, r_{FC}, r_{UC}, and r₀ are unit virtual resistances of the battery, fuel cell, ultra-capacitor, and DC-bus, respectively. The time derivative of the energy function is:

$$( 58 )$$

$$\dot{H} ( {I}_{b} , {I}_{FC} , {I}_{UC} , {V}_{0} ) = ( {I}_{FC} - {I}_{FC}^{*} ) ( \frac{{V}_{FC}}{{L}_{FC}} - \frac{{R}_{FC}}{{L}_{FC}} {I}_{FC} - \frac{( 1 - {D}_{1} )}{{L}_{FC}} {V}_{0} - {\dot{I}}_{FC}^{*} ) + ( {I}_{b} - {I}_{b}^{*} ) ( \frac{{E}_{b}}{{L}_{b}} - \frac{{R}_{b}}{{L}_{b}} {I}_{b} - \frac{{D}_{23}}{{L}_{b}} {V}_{0} - {\dot{I}}_{b}^{*} ) + ( {I}_{UC} - {I}_{UC}^{*} ) ( \frac{{V}_{UC}}{{L}_{UC}} - \frac{{R}_{UC}}{{L}_{UC}} {I}_{UC} - \frac{{D}_{45}}{{L}_{UC}} {V}_{0} - {\dot{I}}_{UC}^{*} ) + ( {V}_{0} - {V}_{0}^{*} ) ( \frac{( 1 - {D}_{1} )}{{C}_{0}} {I}_{FC} + \frac{{D}_{12}}{{C}_{0}} {I}_{b} + \frac{{D}_{34}}{{C}_{0}} {I}_{UC} - \frac{1}{{C}_{0}} {I}_{L} - {\dot{V}}_{0}^{*} )$$

Design PB-SMC for system (58) as follows:

$${D}_{1} = - \frac{{L}_{FC}}{{V}_{0}} ( \frac{{V}_{FC}}{{L}_{FC}} - \frac{{R}_{FC}}{{L}_{FC}} {I}_{FC} - \frac{1}{{L}_{FC}} {V}_{0} - {\dot{I}}_{FC}^{*} + {v}_{1} ) , \qquad ( 59 )$$

$${D}_{23} = \frac{{L}_{b}}{{V}_{0}} ( \frac{{E}_{b}}{{L}_{b}} - \frac{{R}_{b}}{{L}_{b}} {I}_{b} - {\dot{I}}_{b}^{*} + {v}_{2} ) , \qquad ( 60 )$$

$${D}_{45} = \frac{{L}_{UC}}{{V}_{0}} ( \frac{{V}_{UC}}{{L}_{UC}} - \frac{{R}_{UC}}{{L}_{UC}} {I}_{UC} - {\dot{I}}_{UC}^{*} + {v}_{3} ) , \qquad ( 61 )$$

$${\dot{V}}_{0}^{*} = ( \frac{( 1 - {D}_{1} )}{{C}_{0}} {I}_{FC} + \frac{{D}_{23}}{{C}_{0}} {I}_{b} + \frac{{D}_{45}}{{C}_{0}} {I}_{UC} - \frac{1}{{C}_{0}} {I}_{L} + {v}_{4} ) , \qquad ( 62 )$$

where v₁, v₂, v₃, and v₄ are auxiliary inputs which will be defined later. Inserting Equations (59)-(62) into the derivative of storage function of Equation (58), yields:

$$\dot{H} ( {I}_{b} , {I}_{FC} , {I}_{UC} , {V}_{0} ) = ( {I}_{FC} - {I}_{FC}^{*} ) {v}_{1} + ( {I}_{b} - {I}_{b}^{*} ) {v}_{2} + ( {I}_{UC} - {I}_{UC}^{*} ) {v}_{3} + ( {V}_{0} - {V}_{0}^{*} ) {v}_{4} \qquad ( 63 )$$

The fractional order PD^{γ} sliding mode surfaces are designed as follows:

$${ζ}_{1} = {D}^{γ} ( {I}_{FC} - {I}_{FC}^{*} ) + {κ}_{1} ( {I}_{FC} - {I}_{FC}^{*} ) , \qquad ( 64 )$$

$${ζ}_{2} = {D}^{γ} ( {I}_{b} - {I}_{b}^{*} ) + {κ}_{2} ( {I}_{b} - {I}_{b}^{*} ) , \qquad ( 65 )$$

$${ζ}_{3} = {D}^{γ} ( {I}_{UC} - {I}_{UC}^{*} ) + {κ}_{3} ( {I}_{UC} - {I}_{UC}^{*} ) , \qquad ( 66 )$$

$${ζ}_{4} = {D}^{γ} ( {V}_{0} - {V}_{0}^{*} ) + {κ}_{4} ( {V}_{0} - {V}_{0}^{*} ) , \qquad ( 67 )$$

where κᵢ i=1,2,3,4 are positive constants. The Equations (64)-(67) ensure I_{b}, I_{FC}, I_{UC}, and V₀ can effectively converge to their references. The auxiliary inputs are then established as follows:

$${v}_{1} = - {\underbrace{{α}_{1} ( {I}_{FC} - {I}_{FC}^{*} )}}_{energy shaping} - {\underbrace{{λ}_{1} {ζ}_{1} - {ρ}_{1} tanh ( {ζ}_{1} )}}_{robust terms} , \qquad ( 68 )$$

$${v}_{2} = - {\underbrace{{α}_{2} ( {I}_{b} - {I}_{b}^{*} )}}_{energy shaping} - {\underbrace{{λ}_{2} {ζ}_{2} - {ρ}_{2} tanh ( {ζ}_{2} )}}_{robust terms} , \qquad ( 69 )$$

$${v}_{3} = - {\underbrace{{α}_{3} ( {I}_{UC} - {I}_{UC}^{*} )}}_{energy shaping} - {\underbrace{{λ}_{3} {ζ}_{3} - {ρ}_{2} tanh ( {ζ}_{3} )}}_{robust terms} , \qquad ( 70 )$$

$${v}_{4} = - {\underbrace{{α}_{4} ( {V}_{0} - {V}_{0}^{*} )}}_{energy shaping} - {\underbrace{{λ}_{4} {ζ}_{4} - {ρ}_{4} tanh ( {ζ}_{4} )}}_{robust terms} , \qquad ( 71 )$$

where αᵢ i=1, 2, 3, 4 and λᵢ i=1, 2, 3, 4 are positive constants. Substituting Equations (68)-(71) into equation 63 gives:

$$( 72 )$$

$$\dot{H} ( {I}_{b} , {I}_{FC} , {I}_{UC} , {V}_{0} ) \leq - {α}_{1} {\vert {z}_{1} \vert}^{2} - {α}_{2} {\vert {z}_{2} \vert}^{2} - {α}_{3} {\vert {z}_{3} \vert}^{2} - {α}_{4} {\vert {z}_{4} \vert}^{2} - {\overline{α}}_{1} \vert {z}_{1} \vert - {\overline{α}}_{2} \vert {z}_{2} \vert - {\overline{α}}_{3} \vert {z}_{3} \vert - {\overline{α}}_{4} \vert {z}_{4} \vert$$

$$where$$

$$\vert {λ}_{1} {ζ}_{1} + {ρ}_{1} tanh ( {ζ}_{1} ) \vert \leq {\overline{α}}_{1} , \vert {λ}_{2} {ζ}_{2} + {ρ}_{2} tanh ( {ζ}_{2} ) \vert \leq {\overline{α}}_{2} , \vert {λ}_{3} {ζ}_{3} + {ρ}_{3} tanh ( {ζ}_{3} ) \vert \leq {\overline{α}}_{3} ,$$

$$and$$

$$\vert {λ}_{4} {ζ}_{{4}^{+ {ρ}_{4}}} tanh ( {ζ}_{4} ) \vert \leq {\overline{α}}_{4} .$$

### Examples and Experiments

The following examples are provided to illustrate further and to facilitate the understanding of the present disclosure.

### Experimental Data and Analysis

### First Experiment: Determining the Accuracy and Performance of the Duty Cycle Controller

The first experiment was carried out to determine the accuracy and performance of the duty cycle controller 330. To validate the accuracy and performance of the duty cycle controller 330 given by Equations (59)-(62), simulations were performed in MATLAB/Simulink software installed on a 64-bit PC with Intel® Core™ i7-10510U CPU @ 1.8 GHz and 8 Gb RAM. The simulation steps were described as follows:
1. The comprehensive mathematical model of the FCHEV was built in MATLAB/Simulink.
2. The initial condition of each of the dynamic equations of the FCHEV was set as 0.01.
3. The duty cycle controller 330 was incorporated into the dynamic model of the FCHEV to obtain the closed-loop system.
4. The gains of the duty cycle controller 330 were tuned by trial and error. The gains were selected such that the desired responses are obtained.
5. To validate the performance of the duty cycle controller 330, some existing control techniques were implemented to the FCHEV dynamic model.
6. The responses of the FCHEV under the action of the duty cycle controller 330 and the existing control methods were observed and compared.

The performance of the duty cycle controller 330 was further validated through comparison with backstepping and variable structure control techniques. In control theory, backstepping is a control technique that is employed for designing stabilizing controls for a special class of nonlinear dynamical systems. These nonlinear dynamical systems are built from subsystems that radiate out from an irreducible subsystem that can be stabilized using some other method. Because of this recursive structure, the design process can be started at the known-stable system and “back out” new controllers that progressively stabilize each outer subsystem. In an example, a variable structure control (VSC) technique is a form of discontinuous nonlinear control. The VSC alters the dynamics of a nonlinear system by an application of a high-frequency switching control. The various gain values of the duty cycle controller 330 are given in Table 1. The parameters and ratings of the FCHEV system 300 are given in Table 2.

TABLE 1
Controller gains of the FCHEV system 300.

| Parameters | Minimum | |
|---|---|---|
| Battery module | 288 v/13.9 Ah | |
| PEMFC | 350 V/250 A/34 kw | |
| Ultra-capacitor | 205 V/2700 F | |
| module | | |
| C₀ | 1.66 | mF |
| l_{B}, l_{FC} and l_{UC} | 3.30 | mH |
| R_{B}, R_{FC}, and R_{UC} | 20.0 | mΩ |
| Switching frequency | 100 | KHz |
| A | 1.8 | m² |
| Cᵣ | 0.0048 | |
| Cₓ | 0.19 | |
| g | 9.81 | N/kg |
| M | 1066 | kg |
| ρₐ | 1.223 | kg/m³ |

TABLE 2
Parameters and ratings of the FCHEV system 300.

| Controller gains | Values |
|---|---|
| γ | 0.5 |
| κ₁, κ₂, κ₃, and κ₄ | 3, 3, 2, and 4 |
| α₁, α₂, α₃, and α₄ | 6, 5, 4, and 7 |
| λ₁, λ₂, λ₃, and λ₄ | 4, 4, 3, and 5 |
| ρ₁, ρ₂, ρ₃, and ρ₄ | 2, 2, 2, and 3 |

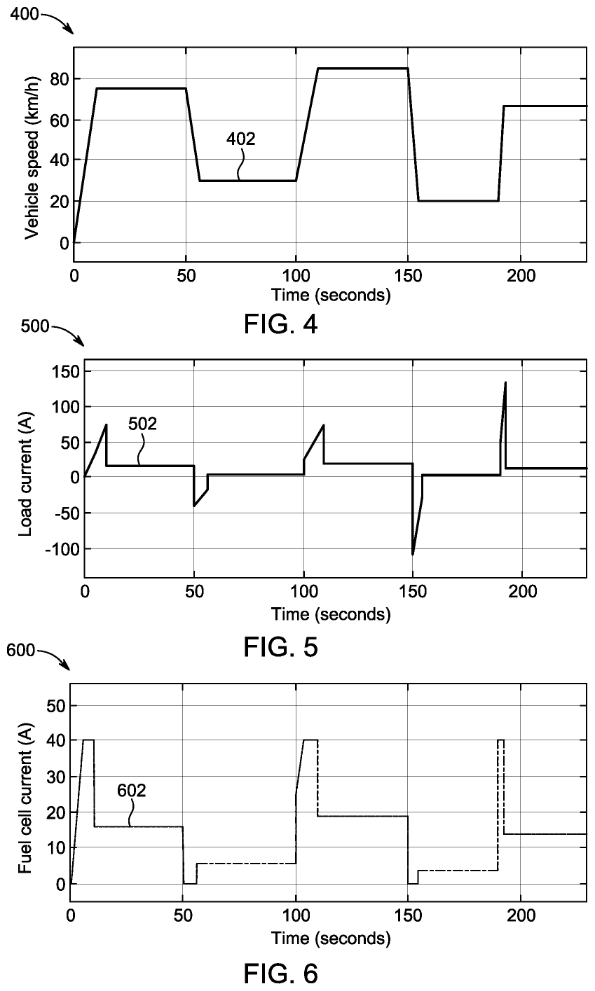

FIG. 4 is a graph 400 of a driving cycle profile. Curve 402 illustrates vehicle speed over the time. The driving cycle profile shows acceleration, constant speed, and deceleration of the FCHEV. In this example, the driving cycle profile lasted for 230 s and covered 8.31 km.

FIG. 5 is a graph 500 of the load current requirement for the different speeds of the FCHEV 100. Curve 502 illustrates the load current requirement over the same time period as FIG. 4.

FIG. 6 is a graph 600 of a tracking curve of the fuel cell current supplied to the load. As shown in FIG. 6, during low current demand (I_{FC}<40 A), the PEMFC 304 supplies current to the load alone. However, during high load demand (I_{FC}>40 A) and deceleration, the PEMFC 304 neither supplies nor receives current so as to prevent degradation of the fuel cell. Curve 602 illustrates fuel cell current supplied to the load over the time period. In an example, the PEMFC current I_{FC} and the reference PEMFC current I_{FC}* are equal.

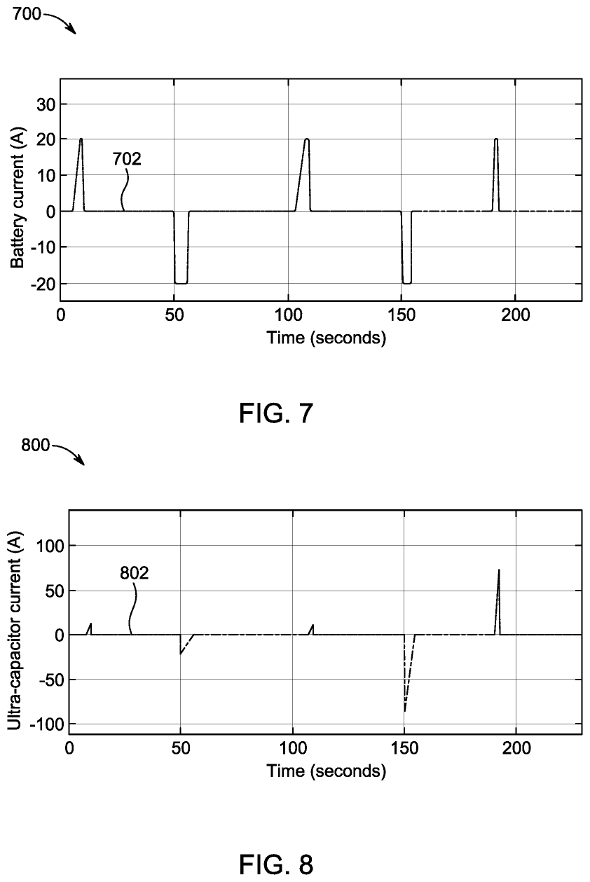

FIG. 7 illustrates a tracking curve 700 of the battery current. As shown in FIG. 7, the battery is discharging during high load demand and acceleration to provide the current that the fuel cell cannot provide. Moreover, the battery is charging by recovering the negative current during deceleration. Curve 702 illustrates battery current during charging and discharging modes. In an example, a current limiter is employed to maintain the battery current within (−20≤I*_{b}≤20 A) to prolong the lifespan of the battery. In an example, the battery current I_{b} and the reference battery current I* are equal.

FIG. 8 illustrates a tracking curve 800 of an ultra-capacitor current. Curve 802 illustrates the ultra-capacitor current during charging and discharging modes. As shown in FIG. 8, during high load demand, both battery and fuel cell cannot provide the peak load current demand due to their low power densities. The ultra-capacitor discharges to meet the peak load current demand to relieve the stress on the battery and fuel cell. On the other hand, the ultra-capacitor charges by recovering the peak negative current during regenerative braking to relieve stress on the battery. In an example, the UC current I_{UC} and the reference UC current I_{UC}*are equal.

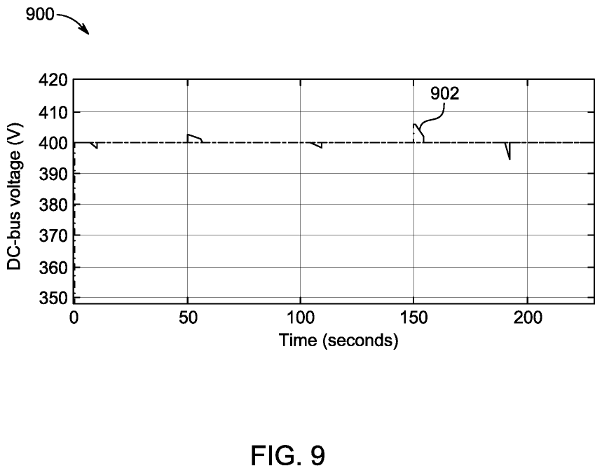

FIG. 9 is a graph 900 of a tracking curve of a DC-bus voltage. As shown in FIG. 9, the DC-bus voltage fluctuated between 394 V and 406 V when the vehicle accelerates or decelerates. Whenever the voltage fluctuated, the duty cycle controller 330 restored the voltage to the reference value very quickly. Curve 902 illustrates the DC-bus voltage of the FCHEV during the driving cycle. In an example, the bus voltage V₀ and the reference bus voltage V₀* are equal.

From FIG. 4-FIG. 9, it can be observed that I_{FC}, I_{b}, I_{UC}, and V₀ accurately track their respective references for various load conditions under the duty cycle controller. Therefore, the duty cycle controller 330 ensures that each of the energy sources supplies the appropriate current to meet the load demand according to the energy management strategy performed by the energy management controller 320.

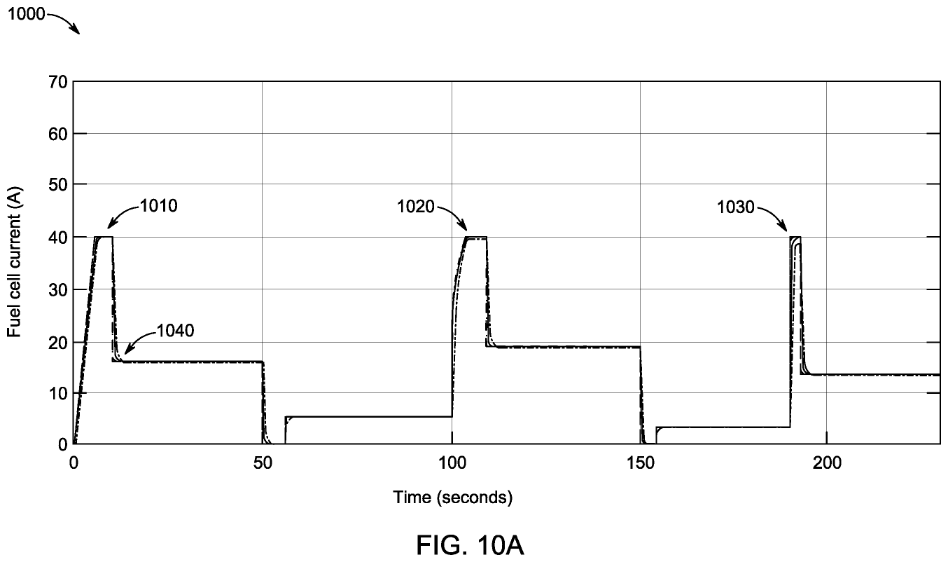

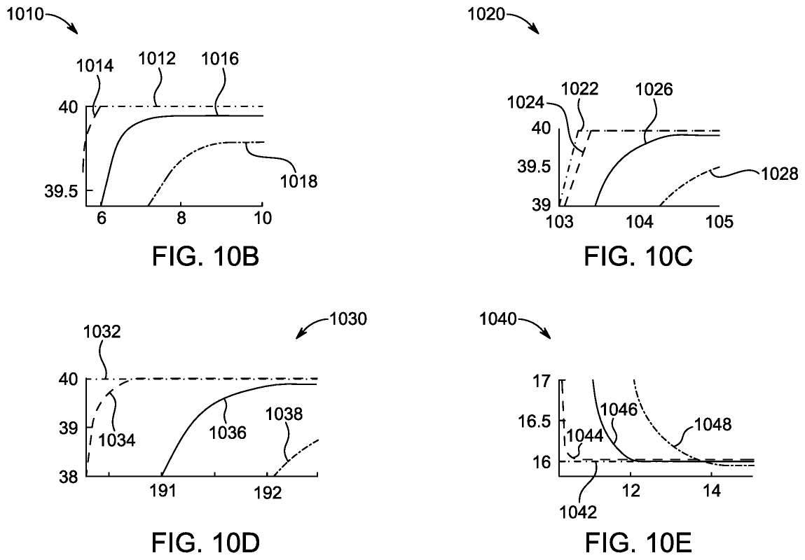

FIG. 10A is a graph 1000 of the fuel cell current under various control techniques, according to aspects of the present disclosure. FIG. 10A illustrates four enlarged windows corresponding to different fuel cell currents over the time.

FIG. 10B is a graph 1010 of the fuel cell current when the fuel cell current is 40 A. Curve 1012 represents a reference PEMFC current I_{FC}*, and curve 1014 represents the passivity-based power distribution control system 300. Curve 1016 represents backstepping control, and curve 1018 represents variable structure control.

FIG. 10C is a graph 1020 of the fuel cell current when the fuel cell current is 40 A at t=103 sec. Curve 1022 represents a reference PEMFC current I_{FC}*, and curve 1024 represents the passivity-based power distribution control system 300. Curve 1026 represents backstepping control, and curve 1028 represents variable structure control.

FIG. 10D is a graph 1030 of the fuel cell current when the fuel cell current is 40 A at t=190 sec. Curve 1032 represents a reference PEMFC current I_{FC}*, and curve 1034 represents the passivity-based power distribution control system 300. Curve 1036 represents backstepping control, and curve 1038 represents variable structure control.

FIG. 10E is a graph 1040 of the fuel cell current when the fuel cell current is 17 A. Curve 1042 represents a reference PEMFC current I_{FC}*, and curve 1044 represents the passivity-based power distribution control system 300. Curve 1046 represents backstepping control, and curve 1048 represents variable structure control.

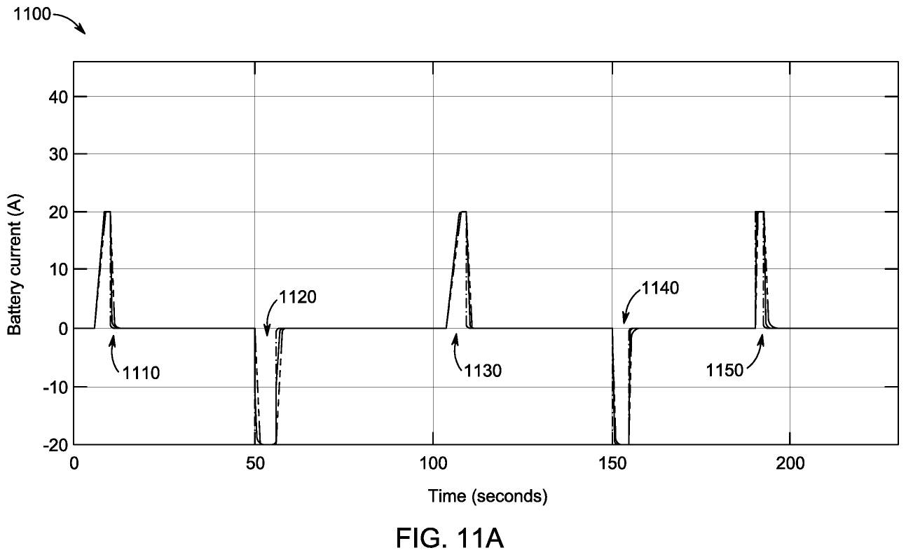

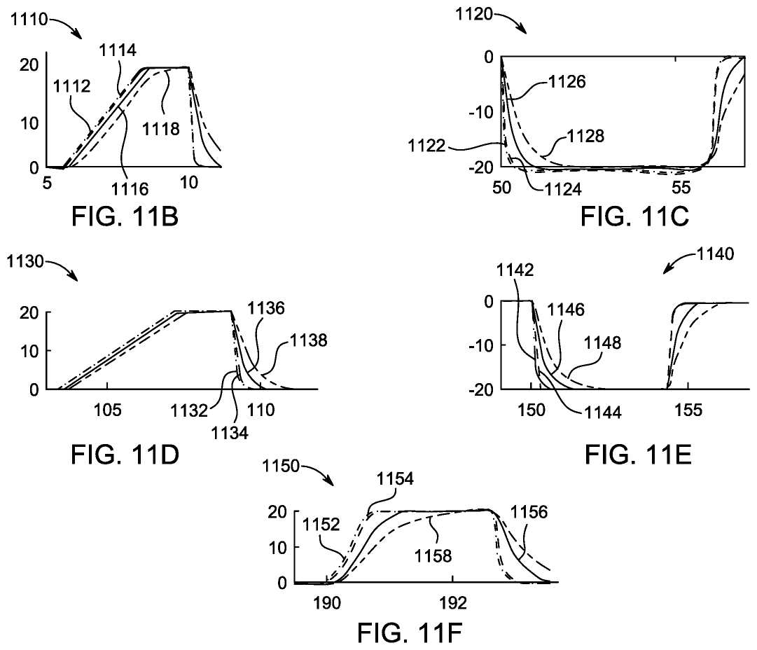

FIG. 11A is a graph 1100 of the battery current under various control techniques.

FIG. 11A illustrates five enlarged windows corresponding to different battery currents through the time.

FIG. 11B is a graph 1110 of the battery current when the battery current lies between 0-20 A. Curve 1112 represents a reference battery current I_{b}*, and curve 1114 represents the passivity-based power distribution control system 300. Curve 1116 represents backstepping control, and curve 1118 represents variable structure control.

FIG. 11C is a graph 1120 of the battery current when the battery current lies in between 0-−20 A. Curve 1122 represents a reference battery current I_{b}*, and curve 1124 represents the passivity-based power distribution control system 300. Curve 1126 represents backstepping control, and curve 1128 represents variable structure control.

FIG. 11D is a graph 1130 of the battery current when the battery current lies in between 0-20 A at t=103 sec(approx.). Curve 1132 represents a reference battery current I_{b}*, and curve 1134 represents the passivity-based power distribution control system 300. Curve 1136 represents backstepping control, and curve 1138 represents variable structure control.

FIG. 11E is a graph 1140 of the battery current when the battery current lies between 0-−20 A at t=150 sec. Curve 1142 represents a reference battery current I_{b}*, and curve 1144 represents the passivity-based power distribution control system 300. Curve 1146 represents backstepping control, and curve 1148 represents variable structure control.

FIG. 11F is a graph 1150 represents the battery current when the battery current lies between 0-20 A at t=190 sec. Curve 1152 represents a reference battery current I_{b}*, and curve 1154 represents the passivity-based power distribution control system 300. Curve 1156 represents backstepping control, and curve 1158 represents variable structure control.

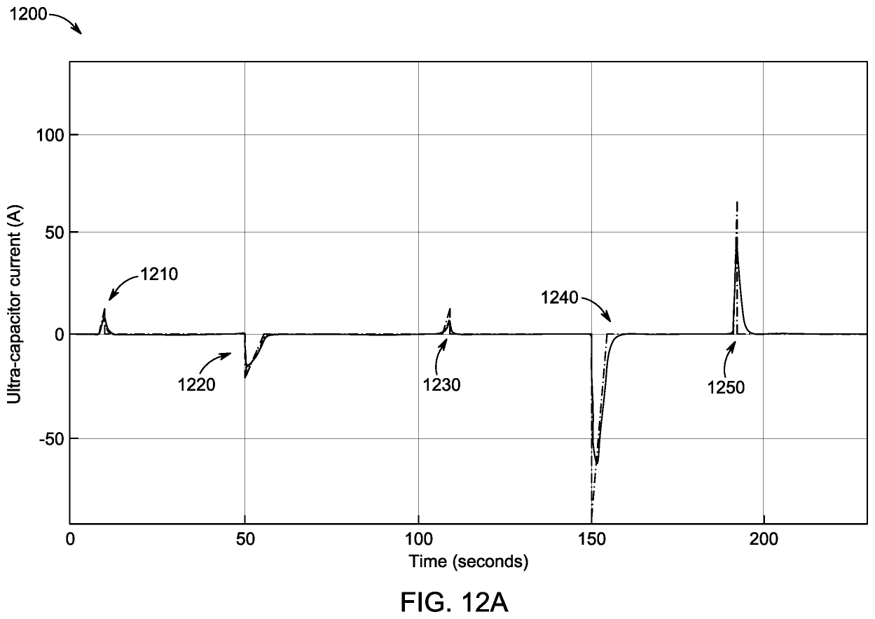

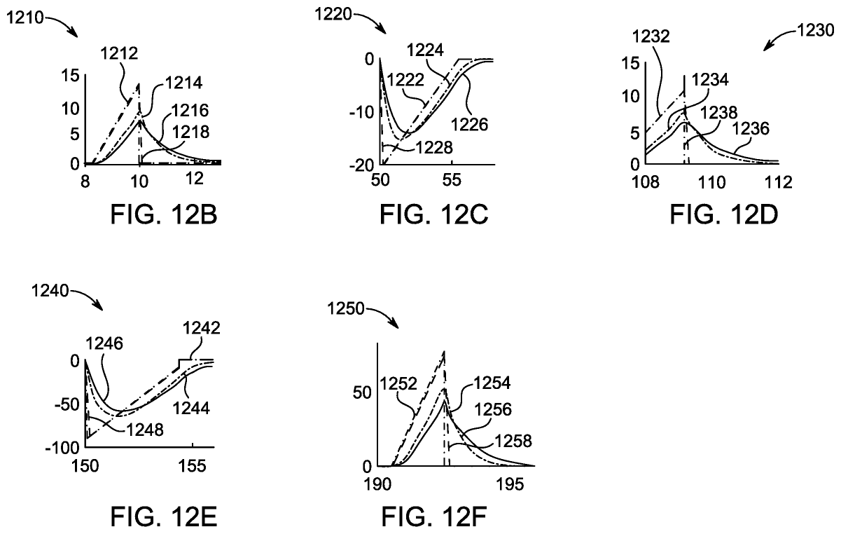

FIG. 12A is a graph 1200 of the ultra-capacitor current under various control techniques, according to aspects of the present disclosure. FIG. 12A illustrates five enlarged windows corresponding to different ultra-capacitor currents over the time period.

FIG. 12B is a graph 1210 of the ultra-capacitor current when the ultra-capacitor current lies between 0-15 A. Curve 1212 represents variable structure control, and curve 1214 represents the passivity-based power distribution control system 300. Curve 1216 represents backstepping control, and curve 1218 represents a reference UC current I_{UC}*.

FIG. 12C is a graph 1220 of the ultra-capacitor current when the ultra-capacitor current lies between 0-20 A. Curve 1224 represents variable structure control, and curve 1222 represents the passivity-based power distribution control system 300. Curve 1226 represents backstepping control, and curve 1228 represents a reference UC current I_{UC}*.

FIG. 12D is a graph 1230 of the ultra-capacitor current when the ultra-capacitor current lies between 0-15 A, at t=108 sec. Curve 1232 represents a reference UC current I_{UC}*. Curve 1234 represents variable structure control. Curve 1236 represents backstepping control, and curve 1238 represents the passivity-based power distribution control system 300.

FIG. 12E is a graph 1240 of the ultra-capacitor current when the ultra-capacitor current lies between 0-−100 A. Curve 1242 represents a reference UC current I_{UC}*. Curve 1244 represents variable structure control. Curve 1246 represents backstepping control, and curve 1248 represents the passivity-based power distribution control system 300.

FIG. 12F is a graph 1250 of the ultra-capacitor current when the ultra-capacitor current lies between 0-100 A. Curve 1252 represents a reference UC current I_{UC}*. Curve 1254 represents variable structure control. Curve 1256 represents backstepping control, and curve 1258 represents the passivity-based power distribution control system 300.

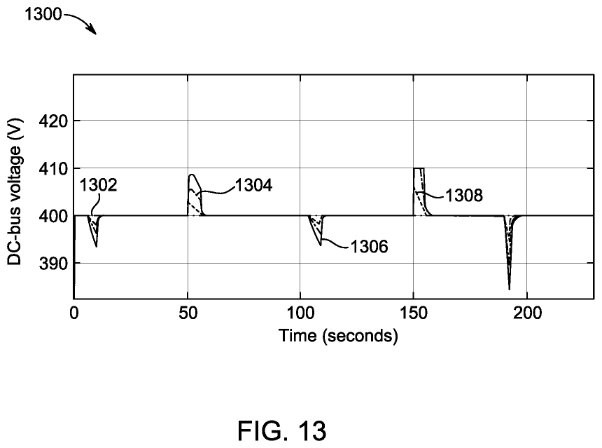

FIG. 13 is a graph 1300 of DC-bus voltage under various control techniques, according to aspects of the present disclosure. Curve 1302 represents a reference bus voltage V₀*. Curve 1304 represents variable structure control. Curve 1306 represents backstepping control. Curve 1308 represents the passivity-based power distribution control system 300.

The comparison results between the passivity-based power distribution control system 300, backstepping control, and variable structure control method are depicted in FIG. 10A-FIG. 13. From FIG. 10A-FIG. 13, it can be observed that the three control methods provide relatively good tracking results. However, whenever the load demand varies, the passivity-based power distribution control system 300 provides the required currents and stabilizes the DC-bus voltage timely and accurately, unlike the other two conventional solutions.

In the present disclosure, a robust passivity-based control of the FCHEV equipped with fuel cell as the main source, and battery and ultra-capacitor as secondary sources has been described. The current contributions of the energy sources to the load is established based on an energy management strategy. The control of the energy sources is realized via the control of the power converters interfacing the energy sources with the DC-bus. The duty cycle controller 330 ensures that the currents of the battery, fuel cell, and ultra-capacitor are tracking their references according to the current sharing rule to meet the load requirement in all driving conditions.

The first embodiment is illustrated with respect to FIGS. 1-13. The first embodiment describes the passivity-based power distribution control system 300 for a hybrid electric vehicle. The system 300 includes a proton-exchange membrane fuel cell module 302 including a proton-exchange membrane fuel cell (PEMFC) 304 and a PEMFC boost converter 306 coupled to the PEMFC, wherein the PEMFC module 302 is configured to generate a PEMFC current I_{FC}, a battery module 308 including a battery 310 and a battery buck/boost converter 312 coupled to the rechargeable battery, wherein battery module 308 is configured to generate a battery current I_{b}, an ultra-capacitor module 314 including an ultra-capacitor (UC) 316 and a UC buck/boost converter 318 coupled to the UC, wherein the UC module 314 is configured to generate a UC current I_{UC}, and a duty cycle controller 330 coupled to the battery module, the proton-exchange membrane fuel cell module and the ultra-capacitor module, wherein the duty cycle controller 330 is configured to control a PEMFC duty cycle D₁ of the PEMFC boost converter 306, a battery duty cycle D₂₃ of the battery buck/boost converter, and a UC duty cycle D₄₅ of the UC buck/boost converter 318.

In an aspect, the passivity-based power distribution control system includes a bus capacitor C₀ connected in parallel with the DC bus, a DC bus 322 connected to the PEMFC boost converter 306, the battery buck/boost converter 312 and the UC buck/boost converter 318, wherein the PEMFC boost converter 306, the battery buck/boost converter 312 and the UC buck/boost converter 318 are configured to receive the PEMFC duty cycle D₁, the battery duty cycle D₂₃, and the UC duty cycle D₄₅ respectively and transmit the PEMFC current I_{FC}, the battery current I_{b} and the UC current I_{UC} respectively to the DC bus, wherein the DC bus 322 has a bus voltage V₀ formed across the bus capacitor C₀ by the PEMFC current I_{FC}, the battery current I_{b} and the UC current I_{UC} and wherein the DC bus 322 is configured to transmit a DC bus load current I_{L} to the drive train of the hybrid electric vehicle.

In an aspect, the passivity-based power distribution control system includes an energy management controller 320 connected to the DC bus, wherein the energy management controller 320 is configured to receive the DC bus load current I_{L} and generate a reference PEMFC current I_{FC}*, a reference battery current I_{b}* and a reference UC current I_{UC}*. The duty cycle controller 330 includes a DC bus connection port configured to receive the bus voltage V₀, a first input port 332 configured to receive the PEMFC current I_{FC}, a second input port 333 configured to receive the battery current I_{b}, a third input port 334 configured to receive the UC current I_{UC}, a first reference input port 335 configured to receive a reference bus voltage V₀*, a second reference input port 336 configured to receive the reference PEMFC current I_{FC}*, a third reference input port 337 configured to receive the reference battery current I_{b}*, a fourth reference input port 338 configured to receive the reference UC current I_{UC}*, wherein the duty cycle controller 330 further comprises a circuitry 339, a memory storing program instructions and at least one processor configured to execute the program instructions to: subtract the reference voltage V₀* from the bus voltage V₀, subtract the reference PEMFC current I_{FC}* from the PEMFC current I_{FC}, and generate the PEMFC duty cycle D₁, subtract the reference battery current I_{b}* from the battery current I_{b}, and generate the battery duty cycle D₂₃, subtract the reference UC current, I_{UC}* from the UC current I_{UC} and generate the UC duty cycle D₄₅, and transmit the PEMFC duty cycle D₁, the battery duty cycle D₂₃ and the UC duty cycle D₄₅, to the PEMFC boost converter 306, the battery buck/boost converter 312 and the UC buck/boost converter 318, respectively.

In an aspect, the duty cycle controller 330 includes a circuitry 339, a memory 340 storing program instructions and at least one processor 341 configured to execute the program instructions to: determine a set of tracking error variables, relate the tracking error variables to the duty cycles D₁, D₂₃ and D₄₅, formulate a stored energy function consisting of the sum of a resistive heat produced by the currents I_{FC}, I_{b} and I_{UC} flowing through the PEMFC, the battery, the ultra-capacitor and the DC bus, and calculate a time derivative of the stored energy function.

In an aspect, the duty cycle controller 330 is further configured to: formulate a first equation which defines the PEMFC duty cycle D₁ in terms of each component of the PEMFC current I_{FC} in the PEMFC module minus the reference PEMFC current I_{FC}* minus an auxiliary term v₁, formulate a second equation which defines the battery duty cycle D₂₃ in terms of each component of the battery current I_{FC} in the battery module minus the reference battery current I_{b}* minus an auxiliary term v₂, formulate a third equation which defines the UC duty cycle D₄₅ in terms of each component of the UC current I_{UC} in the UC module 314 minus the reference UC current I_{UC}* minus an auxiliary term v₃ and formulate a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor C₀ by the battery current I_{b}, a UC voltage generated across the bus capacitor C₀ by the UC current I_{UC}, an auxiliary term v₄, minus a load voltage generated across the bus capacitor C₀ by the load current I_{L}.

In an aspect, the duty cycle controller 330 is further configured to substitute the first equation, the second equation, the third equation and the fourth equation into the derivative of the stored energy function to formulate the stored energy equation in terms of the auxiliary terms v₁, v₂, v₃ and v₄.

In an aspect, the duty cycle controller 330 is further configured to: formulate a set of fractional order sliding mode surfaces from the derivative of the stored energy function, and redefine the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface.

In an aspect, the duty cycle controller 330 is further configured to: substitute the redefined auxiliary terms into the stored energy equation, and bound the stored energy equation by an equation formulated to include a weighted sum of a squared value of each tracking error minus an absolute value of each tracking error, wherein the bounded stored energy equation is configured to force the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

The second embodiment is illustrated with respect to FIGS. 1-13. The embodiment describes a method for passivity-based power distribution control of a drive train of a hybrid electric vehicle. The method includes building a proton-exchange membrane fuel cell module by connecting a proton-exchange membrane fuel cell (PEMFC) to a PEMFC boost converter 306. The method includes building a battery module 308 by connecting a rechargeable battery 310 to a battery buck/boost converter. The method includes building an ultra-capacitor module 314 by connecting an ultra-capacitor (UC) to a UC buck/boost converter 318. The method includes connecting a DC bus 322 in parallel with a capacitor C₀, wherein the DC bus 322 has a bus voltage V₀. The method includes connecting the PEMFC module, the battery module 308 and the ultra-capacitor module 314 to the DC bus. The method includes connecting a duty cycle controller 330 to the PEMFC boost converter 306, the battery buck/boost converter 312 and the ultra-capacitor buck/boost converter. The method includes transmitting, by the duty cycle controller, a PEMFC duty cycle D₁ to the PEMFC boost converter 306, a battery duty cycle D₂₃ to the battery buck/boost converter, and a UC duty cycle D₄₅ to the UC buck/boost converter 318. The method includes generating a PEMFC current I_{FC} by the PEMFC module. The method includes transmitting, by the PEMFC boost converter 306, the PEMFC current I_{FC} to the DC bus 322 at a timing defined by the duty cycle D₁. The method includes generating a battery current I_{b} by the battery module. The method includes transmitting, by the battery buck/boost converter, the battery current I_{b} to the DC bus 322 at a timing defined by the duty cycle D₂₃. The method includes generating a UC current I_{UC} by the UC module 314. The method includes transmitting, by the UC buck/boost converter 318, the UC current I_{UC} to the DC bus 322 at a timing defined by the duty cycle D₄₅. The method further includes transmitting a DC bus load current I_{L} to the drive train of the hybrid electric vehicle.

In an aspect, the DC bus 322 has a bus voltage V₀ formed across the bus capacitor C₀ by the PEMFC current I_{FC}, the battery current I_{b} and the UC current I_{UC}.

In an aspect, the method further includes connecting an energy management controller 320 between the DC bus 322 and the duty cycle controller, receiving, by the energy management controller, the DC bus load current I_{L}. The method further includes generating, by the energy management controller, a reference PEMFC current I_{FC}*, a reference battery current I_{b} and a reference UC current I_{UC}*. The method further includes receiving, at a DC bus connection port of the duty cycle controller, the bus voltage V₀. The method further includes receiving, at a first input port 332 of the duty cycle controller, the PEMFC current I_{FC}. The method further includes receiving, at a second input port 333 of the duty cycle controller, the battery current I_{b}. The method further includes receiving, at a third input port 334 of the duty cycle controller, the UC current I_{UC}. The method further includes receiving, at a first reference input port 335 of the duty cycle controller, a reference bus voltage V₀*. The method further includes receiving, at a second reference input port 336 of the duty cycle controller, the reference PEMFC current I_{FC}*. The method further includes receiving, at a third reference input port 337 of the duty cycle controller, the reference battery current I_{b}*. The method further includes receiving, at a fourth reference input port 338 of the duty cycle controller, the reference UC current I_{UC}*. The method further includes subtracting, by the duty cycle controller 330 which includes a circuitry 339, a memory storing program instructions and at least one processor configured for executing the program instructions, the reference voltage V₀* from the bus voltage V₀. The method further includes subtracting, by the duty cycle controller, the reference PEMFC current I_{FC}* from the PEMFC current I_{FC}, and generating the PEMFC duty cycle D₁. The method further includes subtracting, by the duty cycle controller, the reference battery current I_{b}* from the battery current I_{b}, and generate the battery duty cycle D₂₃. The method further includes subtracting, by the duty cycle controller, the reference UC current, I_{UC}* from the UC current I_{UC} and generating the UC duty cycle D₄₅. The method further includes transmitting, by the duty cycle controller, the PEMFC duty cycle D₁, the battery duty cycle D₂₃ and the UC duty cycle D₄₅, to the PEMFC boost converter 306, the battery buck/boost converter 312 and the UC buck/boost converter 318, respectively.

In an aspect, the method includes executing by the at least one processor of the duty cycle controller, the program instructions to perform the steps of: determining a set of tracking error variables, relating the tracking error variables to the duty cycles D₁, D₂₃ and D₄₅, formulating a stored energy function consisting of the sum of a resistive heat produced by the currents I_{FC}, I_{b} and I_{UC} flowing through the PEMFC, the battery, the ultra-capacitor and the DC bus, and calculating a time derivative of the stored energy function.

In an aspect, the method includes executing by the at least one processor of the duty cycle controller, the program instructions to perform the steps of: formulating a first equation which defines the PEMFC duty cycle D₁ in terms of each component of the PEMFC current I_{FC} in the PEMFC module minus the reference PEMFC current I_{FC}* minus an auxiliary term v₁, formulating a second equation which defines the battery duty cycle D₂₃ in terms of each component of the battery current I_{FC} in the battery module minus the reference battery current I_{b}* minus an auxiliary term v₂, formulating a third equation which defines the UC duty cycle D₄₅ in terms of each component of the UC current I_{UC} in the UC module 314 minus the reference UC current I_{UC}* minus an auxiliary term v₃, and formulating a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor by the battery current I_{b}, a UC voltage generated across the bus capacitor by the UC current I_{UC}, an auxiliary term v₄, minus a load voltage generated across the bus capacitor by the load current I_{L}.

In an aspect, the method includes executing by the at least one processor of the duty cycle controller 330, the program instructions to perform the step of substituting the first equation, the second equation, the third equation and the fourth equation into the derivative of the stored energy function to formulate the stored energy equation in terms of the auxiliary terms v₁, v₂, v₃ and v₄.

In an aspect, the method includes executing by the at least one processor of the duty cycle controller, the program instructions to perform the steps of: formulating a set of fractional order sliding mode surfaces from the derivative of the stored energy function, and redefining the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface.

In an aspect, the method includes executing by the at least one processor of the duty cycle controller, the program instructions to perform the steps of: substituting the redefined auxiliary terms into the stored energy equation, and bounding the stored energy equation by an equation formulated to include a weighted sum of a squared value of each tracking error minus an absolute value of each tracking error, wherein the bounded stored energy equation is configured for forcing the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

The third embodiment is illustrated with respect to FIGS. 1-13. The embodiment describes a method for passivity-based power distribution control. The method includes transmitting, by a duty cycle controller 330, a PEMFC duty cycle D₁ to a PEMFC boost converter 306, a battery duty cycle D₂₃ to a battery buck/boost converter, and a UC duty cycle D₄₅ to a UC buck/boost converter 318, wherein the PEMFC boost converter 306, the battery buck/boost converter, and the UC buck/boost converter 318 are each connected in parallel with a DC bus. The method includes generating a PEMFC current I_{FC} by the PEMFC module. The method includes transmitting, by the PEMFC boost converter 306, the PEMFC current I_{FC} to the DC bus 322 at a timing defined by the duty cycle D₁. The method further includes generating a battery current I_{b} by the battery module. The method further includes transmitting, by the battery buck/boost converter, the battery current I_{b} to the DC bus 322 at a timing defined by the duty cycle D₂₃. The method further includes generating a UC current I_{UC} by the UC module 314. The method further includes transmitting, by the UC buck/boost converter 318, the UC current I_{UC} to the DC bus 322 at a timing defined by the duty cycle D₄₅. The method further includes transmitting a DC bus load current I_{L} to a load.

In an aspect, the method further includes receiving, by an energy management controller, the DC bus load current I_{L}, generating, by the energy management controller, a reference PEMFC current I_{FC}*, a reference battery current I_{b}* and a reference UC current I_{UC}*, receiving, at a DC bus connection port of the duty cycle controller, the bus voltage V₀, receiving, at a first input port 332 of the duty cycle controller, the PEMFC current I_{FC}, receiving, at a second input port 333 of the duty cycle controller, the battery current I_{b}, receiving, at a third input port 334 of the duty cycle controller, the UC current I_{UC}, receiving, at a first reference input port 335 of the duty cycle controller, a reference bus voltage V₀*, receiving, at a second reference input port 336 of the duty cycle controller, the reference PEMFC current I_{FC}*, receiving, at a third reference input port 337 of the duty cycle controller, the reference battery current I_{b}*, receiving, at a fourth reference input port 338 of the duty cycle controller, the reference UC current I_{UC}*, subtracting, by the duty cycle controller 330 which includes a circuitry 339, a memory storing program instructions and at least one processor configured for executing the program instructions, the reference voltage V₀* from the bus voltage V₀, subtracting, by the duty cycle controller, the reference PEMFC current I_{FC}* from the PEMFC current I_{FC}, and generating the PEMFC duty cycle D₁, subtracting, by the duty cycle controller, the reference battery current I_{b}* from the battery current I_{b}, and generating the battery duty cycle D₂₃, subtracting, by the duty cycle controller, the reference UC current, I_{UC}* from the UC current I_{UC} and generating the UC duty cycle D₄₅, and transmitting, by the duty cycle controller, the PEMFC duty cycle D₁, the battery duty cycle D₂₃ and the UC duty cycle D₄₅, to the PEMFC boost converter 306, the battery buck/boost converter 312 and the UC buck/boost converter 318, respectively.

In an aspect, the method further includes determining a set of tracking error variables, relating the tracking error variables to the duty cycles D₁, D₂₃ and D₄₅, formulating a stored energy function consisting of the sum of a resistive heat produced by the currents I_{FC}, I_{b} and I_{UC} flowing through the PEMFC, the battery, the ultra-capacitor and the DC bus, calculating a time derivative of the stored energy function, formulating a first equation which defines the PEMFC duty cycle D₁ in terms of each component of the PEMFC current I_{FC} in the PEMFC module minus the reference PEMFC current I_{FC}* minus an auxiliary term v₁, formulating a second equation which defines the battery duty cycle D₂₃ in terms of each component of the battery current I_{FC} in the battery module minus the reference battery current I_{b}* minus an auxiliary term v₂, formulating a third equation which defines the UC duty cycle D₄₅ in terms of each component of the UC current I_{UC} in the UC module 314 minus the reference UC current I_{UC}* minus an auxiliary term v₃, and formulating a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor by the battery current I_{b}, a UC voltage generated across the bus capacitor by the UC current I_{UC}, an auxiliary term v₄, minus a load voltage generated across the bus capacitor by the load current I_{L}.

In an aspect, the method further includes substituting the first equation, the second equation, the third equation and the fourth equation into the derivative of the stored energy function to formulate the stored energy equation in terms of the auxiliary terms v₁, v₂, v₃ and v₄, formulating a set of fractional order sliding mode surfaces from the derivative of the stored energy function, redefining the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface, substituting the redefined auxiliary terms into the stored energy equation, and bounding the stored energy equation by an equation formulated to include a weighted sum of a squared value of each tracking error minus an absolute value of each tracking error, wherein the bounded stored energy equation is configured for forcing the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

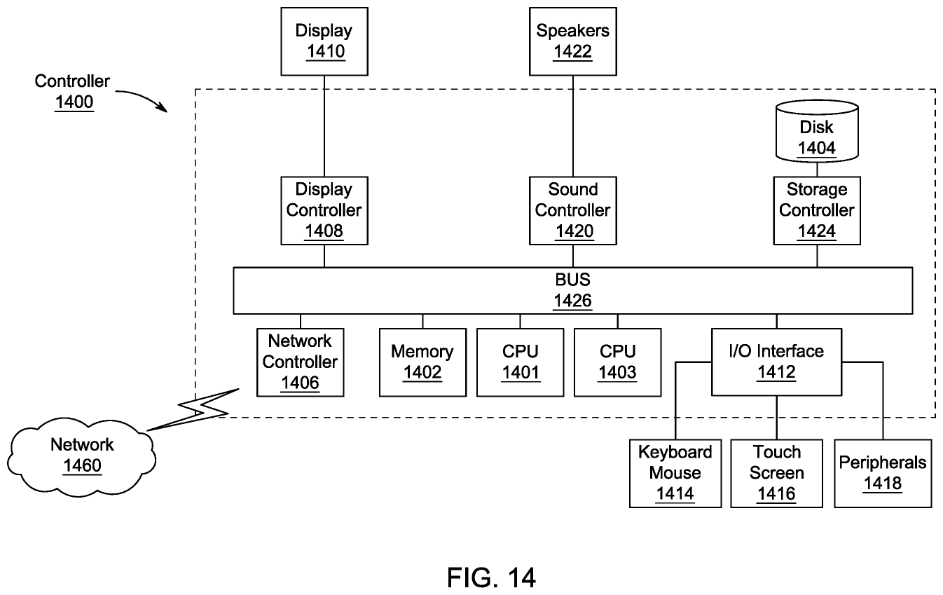

Next, further details of the hardware description of the computing environment of FIG. 3A according to exemplary embodiments is described with reference to FIG. 14.

In FIG. 14, a controller 1400 is described as representative of the passivity-based power distribution control system 300 for a hybrid electric vehicle of FIG. 3A in which each of the duty cycle controller 330, and the energy management controller 320 is a computing device which includes a CPU 1401 which performs the processes described above/below. FIG. 14 is an illustration of a non-limiting example of details of computing hardware used in the computing system, according to exemplary aspects of the present disclosure. In FIG. 14, a controller 1400 is described which is a computing device (that includes the microcontroller 120) and includes a CPU 1401 which performs the processes described above/below. The process data and instructions may be stored in memory 1402. These processes and instructions may also be stored on a storage medium disk 1404 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1401, 1403 and an operating system such as Microsoft Windows 7, UNIX, Solaris, LINUX, Apple MAC-OS and other systems known to those skilled in the art.

The hardware elements in order to achieve the computing device may be realized by various circuitry elements, known to those skilled in the art. For example, CPU 1401 or CPU 1403 may be a Xenon or Core processor from Intel of America or an Opteron processor from AMD of America, or may be other processor types that would be recognized by one of ordinary skill in the art. Alternatively, the CPU 1401, 1403 may be implemented on an FPGA, ASIC, PLD or using discrete logic circuits, as one of the ordinary skill in the art would recognize. Further, CPU 1401, 1403 may be implemented as multiple processors cooperatively working in parallel to perform the instructions of the inventive processes described above.

The computing device in FIG. 14 also includes a network controller 1406, such as an Intel Ethernet PRO network interface card from Intel Corporation of America, for interfacing with network 1460. As can be appreciated, the network 1460 can be a public network, such as the Internet, or a private network such as an LAN or WAN network, or any combination thereof and can also include PSTN or ISDN sub-networks. The network 1460 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 1408, such as a NVIDIA GeForce GTX or Quadro graphics adaptor from NVIDIA Corporation of America for interfacing with display 1410, such as a Hewlett Packard HPL2445w LCD monitor. A general purpose I/O interface 1412 interfaces with a keyboard and/or mouse 1414 as well as a touch screen panel 1416 on or separate from display 1410. General purpose I/O interface also connects to a variety of peripherals 1418 including printers and scanners, such as an OfficeJet or DeskJet from Hewlett Packard.

A sound controller 1420 is also provided in the computing device such as Sound Blaster X-Fi Titanium from Creative, to interface with speakers/microphone 1422 thereby providing sounds and/or music.

The general-purpose storage controller 1424 connects the storage medium disk 1404 with communication bus 1426, which may be an ISA, EISA, VESA, PCI, or similar, for interconnecting all of the components of the computing device. A description of the general features and functionality of the display 1410, keyboard and/or mouse 1414, as well as the display controller 1408, storage controller 1424, network controller 1406, sound controller 1420, and general purpose I/O interface 1412 is omitted herein for brevity as these features are known.

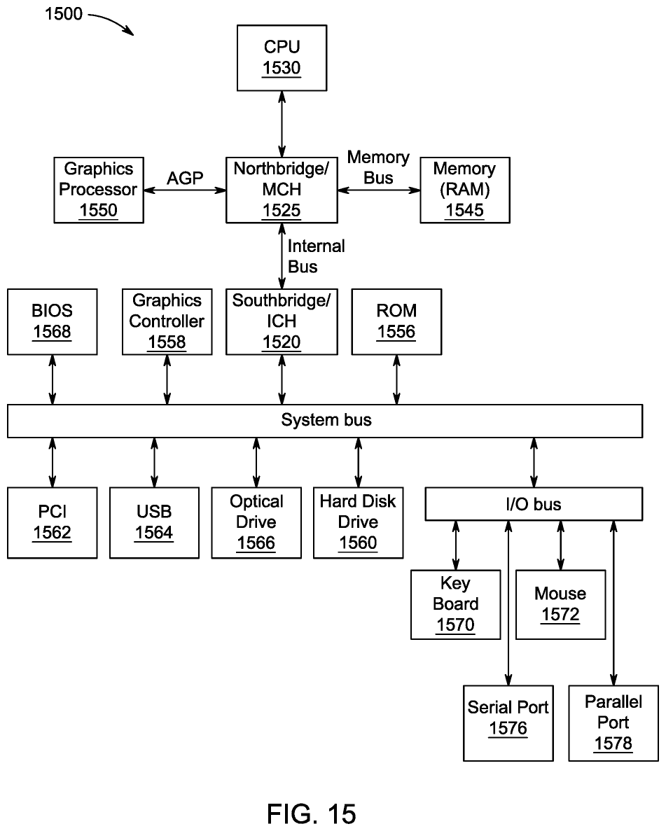

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 15.

FIG. 15 shows a schematic diagram of a data processing system 1500 used within the computing system, according to exemplary aspects of the present disclosure. The data processing system 1500 is an example of a computer in which code or instructions implementing the processes of the illustrative aspects of the present disclosure may be located.

In FIG. 15, data processing system 1580 employs a hub architecture including a north bridge and memory controller hub (NB/MCH) 1525 and a south bridge and input/output (I/O) controller hub (SB/ICH) 1520. The central processing unit (CPU) 1530 is connected to NB/MCH 1525. The NB/MCH 1525 also connects to the memory 1545 via a memory bus, and connects to the graphics processor 1550 via an accelerated graphics port (AGP). The NB/MCH 1525 also connects to the SB/ICH 1520 via an internal bus (e.g., a unified media interface or a direct media interface). The CPU Processing unit 1530 may contain one or more processors and even may be implemented using one or more heterogeneous processor systems.

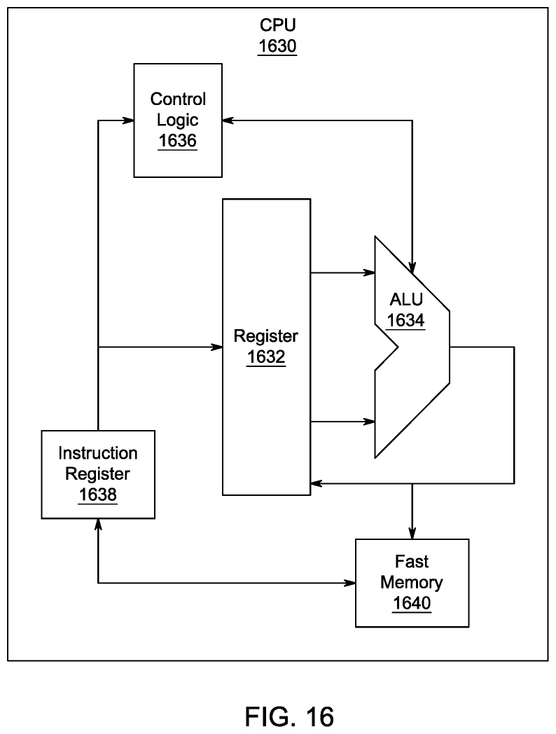

For example, FIG. 16 shows one aspects of the present disclosure of CPU 1530. In one aspects of the present disclosure, the instruction register 1638 retrieves instructions from the fast memory 1640. At least part of these instructions is fetched from the instruction register 1638 by the control logic 1636 and interpreted according to the instruction set architecture of the CPU 1530. Part of the instructions can also be directed to the register 1632. In one aspects of the present disclosure the instructions are decoded according to a hardwired method, and in another aspect of the present disclosure the instructions are decoded according to a microprogram that translates instructions into sets of CPU configuration signals that are applied sequentially over multiple clock pulses. After fetching and decoding the instructions, the instructions are executed using the arithmetic logic unit (ALU) 1634 that loads values from the register 1632 and performs logical and mathematical operations on the loaded values according to the instructions. The results from these operations can be feedback into the register and/or stored in the fast memory 1640. According to certain aspects of the present disclosures, the instruction set architecture of the CPU 1530 can use a reduced instruction set architecture, a complex instruction set architecture, a vector processor architecture, a very large instruction word architecture. Furthermore, the CPU 1530 can be based on the Von Neuman model or the Harvard model. The CPU 1530 can be a digital signal processor, an FPGA, an ASIC, a PLA, a PLD, or a CPLD. Further, the CPU 1530 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 15, the data processing system 1580 can include that the SB/ICH 1520 is coupled through a system bus to an I/O Bus, a read only memory (ROM) 1556, universal serial bus (USB) port 1564, a flash binary input/output system (BIOS) 1568, and a graphics controller 1558. PCI/PCIe devices can also be coupled to SB/ICH 1520 through a PCI bus 1562.

The PCI devices may include, for example, Ethernet adapters, add-in cards, and PC cards for notebook computers. The Hard disk drive 1560 and CD-ROM 1556 can use, for example, an integrated drive electronics (IDE) or serial advanced technology attachment (SATA) interface. In one aspect of the present disclosure the I/O bus can include a super I/O (SIO) device.

Further, the hard disk drive (HDD) 1560 and optical drive 1566 can also be coupled to the SB/ICH 1520 through a system bus. In one aspects of the present disclosure, a keyboard 1570, a mouse 1572, a parallel port 1578, and a serial port 1576 can be connected to the system bus through the I/O bus. Other peripherals and devices that can be connected to the SB/ICH 1520 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

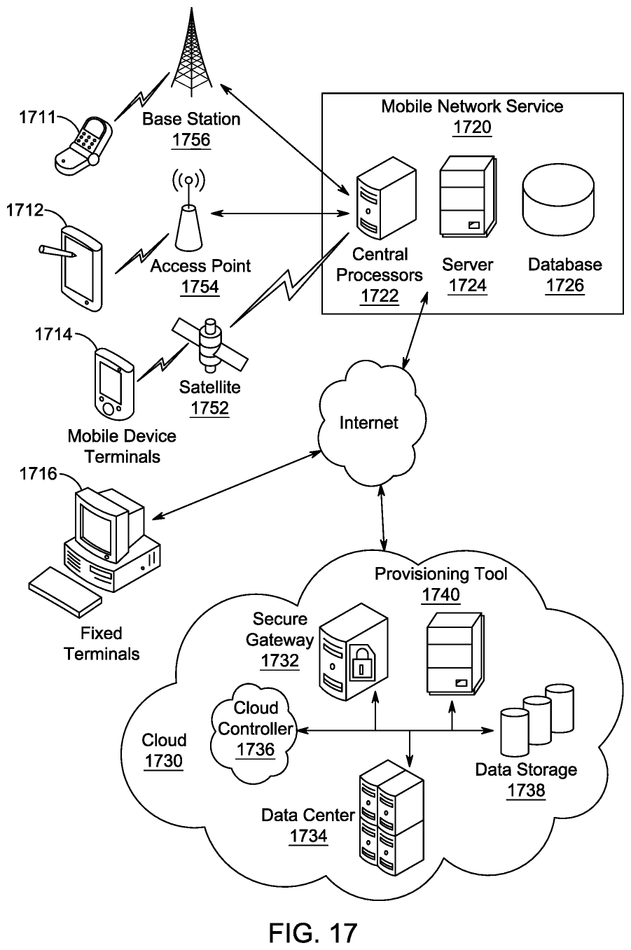

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 17, in addition to various human interface and communication devices (e.g., display monitors, smart phones, tablets, personal digital assistants (PDAs)). More specifically, FIG. 17 illustrates client devices including smart phone 1711, tablet 1712, mobile device terminal 1714 and fixed terminals 1716. These client devices may be commutatively coupled with a mobile network service 1720 via base station 1756, access point 1754, satellite 1752 or via an internet connection. Mobile network service 1720 may comprise central processors 1722, server 1724 and database 1726. Fixed terminals 1716 and mobile network service 1720 may be commutatively coupled via an internet connection to functions in cloud 1730 that may comprise security gateway 1732, data center 1734, cloud controller 1736, data storage 1738 and provisioning tool 1740. The network may be a private network, such as a LAN or WAN, or may be a public network, such as the Internet. Input to the system may be received via direct user input and received remotely either in real-time or as a batch process. Additionally, some aspects of the present disclosures may be performed on modules or hardware not identical to those described. Accordingly, other aspects of the present disclosures are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A passivity-based power distribution control system for a hybrid electric vehicle, comprising:
a proton-exchange membrane fuel cell module including a proton-exchange membrane fuel cell (PEMFC) and a PEMFC boost converter coupled to the PEMFC, wherein the PEMFC module is configured to generate a PEMFC current I_{FC};
a battery module including a battery and a battery buck/boost converter coupled to the rechargeable battery, wherein battery module is configured to generate a battery current I_{b};
an ultra-capacitor module including an ultra-capacitor (UC) and a UC buck/boost converter coupled to the UC, wherein the UC module is configured to generate a UC current I_{UC}; and
a duty cycle controller coupled to the battery module, the proton-exchange membrane fuel cell module and the ultra-capacitor module, wherein the duty cycle controller is configured to control a PEMFC duty cycle D₁ of the PEMFC boost converter, a battery duty cycle D₂₃ of the battery buck/boost converter, and a UC duty cycle D₄₅ of the UC buck/boost converter.

2. The passivity-based power distribution control system of claim 1, further comprising:
a bus capacitor C₀ connected in parallel with the DC bus;
a DC bus connected to the PEMFC boost converter, the battery buck/boost converter and
the UC buck/boost converter, wherein the PEMFC boost converter, the battery buck/boost converter and the UC buck/boost converter are configured to receive the PEMFC duty cycle D₁, the battery duty cycle D₂₃, and the UC duty cycle D₄₅ respectively and transmit the PEMFC current I_{FC}, the battery current I_{b} and the UC current I_{UC} respectively to the DC bus, wherein the DC bus has a bus voltage V₀ formed across the bus capacitor C₀ by the PEMFC current I_{FC}, the battery current I_{b} and the UC current I_{UC} and wherein the DC bus is configured to transmit a DC bus load current I_{L} to the drive train of the hybrid electric vehicle.

3. The passivity-based power distribution control system of claim 2, further comprising:
an energy management controller connected to the DC bus, wherein the energy management controller is configured to receive the DC bus load current I_{L} and generate a reference PEMFC current I_{FC}*, a reference battery current I_{b}* and a reference UC current I_{UC}*;
wherein the duty cycle controller comprises:
a DC bus connection port configured to receive the bus voltage V₀;
a first input port configured to receive the PEMFC current I_{FC};
a second input port configured to receive the battery current I_{b};
a third input port configured to receive the UC current I_{UC};
a first reference input port configured to receive a reference bus voltage V₀*;
a second reference input port configured to receive the reference PEMFC current I_{FC};
a third reference input port configured to receive the reference battery current I_{b}*;
a fourth reference input port configured to receive the reference UC current I_{UC}*;
wherein the duty cycle controller further comprises a circuitry, a memory storing program instructions and at least one processor configured to execute the program instructions to:
subtract the reference voltage V₀* from the bus voltage V₀;
subtract the reference PEMFC current I_{FC}* from the PEMFC current I_{FC}, and generate the PEMFC duty cycle D₁,
subtract the reference battery current I_{b}* from the battery current I_{b}, and generate the battery duty cycle D₂₃,
subtract the reference UC current, I_{UC}* from the UC current I_{UC} and generate the UC duty cycle D₄₅; and
transmit the PEMFC duty cycle D₁, the battery duty cycle D₂₃ and the UC duty cycle D₄₅, to the PEMFC boost converter, the battery buck/boost converter and the UC buck/boost converter, respectively.

4. The passivity-based power distribution control system of claim 3, wherein the duty cycle controller further comprises:
a circuitry, a memory storing program instructions and at least one processor configured to execute the program instructions to:
determine a set of tracking error variables,
relate the tracking error variables to the duty cycles D₁, D₂₃ and D₄₅;
formulate a stored energy function consisting of the sum of a resistive heat produced by the currents I_{FC}, I_{b} and I_{UC} flowing through the PEMFC, the battery, the ultra-capacitor and the DC bus; and
calculate a time derivative of the stored energy function.

5. The passivity-based power distribution control system of claim 4, wherein the duty cycle controller is further configured to:
formulate a first equation which defines the PEMFC duty cycle D₁ in terms of each component of the PEMFC current I_{FC} in the PEMFC module minus the reference PEMFC current I_{FC}* minus an auxiliary term v₁;
formulate a second equation which defines the battery duty cycle D₂₃ in terms of each component of the battery current I_{FC} in the battery module minus the reference battery current I_{b}* minus an auxiliary term v₂;
formulate a third equation which defines the UC duty cycle D₄₅ in terms of each component of the UC current I_{UC} in the UC module minus the reference UC current I_{UC}* minus an auxiliary term v₃; and
formulate a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor by the battery current I_{b}, a UC voltage generated across the bus capacitor by the UC current I_{UC}, an auxiliary term v₄, minus a load voltage generated across the bus capacitor by the load current I_{L}.

6. The passivity-based power distribution control system of claim 5, wherein the duty cycle controller is further configured to substitute the first equation, the second equation, the third equation and the fourth equation into the derivative of the stored energy function to formulate the stored energy equation in terms of the auxiliary terms v₁, v₂, v₃ and v₄.

7. The passivity-based power distribution control system of claim 6, wherein the duty cycle controller is further configured to:
formulate a set of fractional order sliding mode surfaces from the derivative of the stored energy function; and
redefine the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface.

8. The passivity-based power distribution control system of claim 7, wherein the duty cycle controller is further configured to:
substitute the redefined auxiliary terms into the stored energy equation; and
bound the stored energy equation by an equation formulated to include a weighted sum of a squared value of each tracking error minus an absolute value of each tracking error, wherein the bounded stored energy equation is configured to force the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

9. A method for passivity-based power distribution control of a drive train of a hybrid electric vehicle, comprising:
building a proton-exchange membrane fuel cell module by connecting a proton-exchange membrane fuel cell (PEMFC) to a PEMFC boost converter;
building a battery module by connecting a rechargeable battery to a battery buck/boost converter;
building an ultra-capacitor module by connecting an ultra-capacitor (UC) to a UC buck/boost converter;
connecting a DC bus in parallel with a capacitor C₀, wherein the DC bus has a bus voltage V₀;
connecting the PEMFC module, the battery module and the ultra-capacitor module to the DC bus;
connecting a duty cycle controller to the PEMFC boost converter, the battery buck/boost converter and the ultra-capacitor buck/boost converter;
transmitting, by the duty cycle controller, a PEMFC duty cycle D₁ to the PEMFC boost converter, a battery duty cycle D₂₃ to the battery buck/boost converter, and a UC duty cycle D₄₅ to the UC buck/boost converter;
generating a PEMFC current I_{FC} by the PEMFC module;
transmitting, by the PEMFC boost converter, the PEMFC current I_{FC} to the DC bus at a timing defined by the duty cycle D₁;
generating a battery current I_{b} by the battery module;
transmitting, by the battery buck/boost converter, the battery current I_{b} to the DC bus at a timing defined by the duty cycle D₂₃;
generating a UC current I_{UC} by the UC module;
transmitting, by the UC buck/boost converter, the UC current I_{UC} to the DC bus at a timing defined by the duty cycle D₄₅; and
transmitting a DC bus load current I_{L} to the drive train of the hybrid electric vehicle.

10. The method of claim 9, wherein the DC bus has a bus voltage V₀ formed across the bus capacitor C₀ by the PEMFC current I_{FC}, the battery current I_{b} and the UC current I_{UC}.

11. The method of claim 10, further comprising:
connecting an energy management controller between the DC bus and the duty cycle controller, receiving, by the energy management controller, the DC bus load current I_{L};
generating, by the energy management controller, a reference PEMFC current I_{FC}*, a reference battery current I_{b}* and a reference UC current I_{UC}*;
receiving, at a DC bus connection port of the duty cycle controller, the bus voltage V₀;
receiving, at a first input port of the duty cycle controller, the PEMFC current I_{FC};
receiving, at a second input port of the duty cycle controller, the battery current I_{b};
receiving, at a third input port of the duty cycle controller, the UC current I_{UC};
receiving, at a first reference input port of the duty cycle controller, a reference bus voltage V₀*;
receiving, at a second reference input port of the duty cycle controller, the reference PEMFC current I*_{FC};
receiving, at a third reference input port of the duty cycle controller, the reference battery current I_{b}*;
receiving, at a fourth reference input port of the duty cycle controller, the reference UC current I_{UC}*;
subtracting, by the duty cycle controller which includes a circuitry, a memory storing program instructions and at least one processor configured for executing the program instructions, the reference voltage V₀* from the bus voltage V₀;
subtracting, by the duty cycle controller, the reference PEMFC current I_{FC}* from the PEMFC current I_{FC}, and generate the PEMFC duty cycle D₁,
subtracting, by the duty cycle controller, the reference battery current I_{b}* from the battery current I_{b}, and generate the battery duty cycle D₂₃,
subtracting, by the duty cycle controller, the reference UC current, I_{UC}* from the UC current I_{UC} and generate the UC duty cycle D₄₅; and
transmitting, by the duty cycle controller, the PEMFC duty cycle D₁, the battery duty cycle D₂₃ and the UC duty cycle D₄₅, to the PEMFC boost converter, the battery buck/boost converter and the UC buck/boost converter, respectively.

12. The method of claim 11, further comprising executing by the at least one processor of the duty cycle controller, the program instructions to perform the steps of:
determining a set of tracking error variables,
relating the tracking error variables to the duty cycles D₁, D₂₃ and D₄₅;
formulating a stored energy function consisting of the sum of a resistive heat produced by the currents I_{FC}, I_{b} and I_{UC} flowing through the PEMFC, the battery, the ultra-capacitor and the DC bus; and
calculating a time derivative of the stored energy function.

13. The method of claim 12, further comprising executing by the at least one processor of the duty cycle controller, the program instructions to perform the steps of:
formulating a first equation which defines the PEMFC duty cycle D₁ in terms of each component of the PEMFC current I_{FC} in the PEMFC module minus the reference PEMFC current I_{FC}* minus an auxiliary term v₁;
formulating a second equation which defines the battery duty cycle D₂₃ in terms of each component of the battery current I_{FC} in the battery module minus the reference battery current I_{b}* minus an auxiliary term v₂;
formulating a third equation which defines the UC duty cycle D₄₅ in terms of each component of the UC current I_{UC} in the UC module minus the reference UC current I_{UC}* minus an auxiliary term v₃; and
formulating a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor by the battery current I_{b}, a UC voltage generated across the bus capacitor by the UC current I_{UC}, an auxiliary term v₄, minus a load voltage generated across the bus capacitor by the load current I_{L}.

14. The method of claim 13, further comprising executing by the at least one processor of the duty cycle controller, the program instructions to perform the step of substituting the first equation, the second equation, the third equation and the fourth equation into the derivative of the stored energy function to formulate the stored energy equation in terms of the auxiliary terms v₁, v₂, v₃ and v₄.

15. The method of claim 14, further comprising executing by the at least one processor of the duty cycle controller, the program instructions to perform the steps of:
formulating a set of fractional order sliding mode surfaces from the derivative of the stored energy function; and
redefining the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface.

16. The method of claim 15, further comprising executing by the at least one processor of the duty cycle controller, the program instructions to perform the steps of:
substituting the redefined auxiliary terms into the stored energy equation; and
bounding the stored energy equation by an equation formulated to include a weighted sum of a squared value of each tracking error minus an absolute value of each tracking error, wherein the bounded stored energy equation is configured for forcing the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.

17. A method for passivity-based power distribution control, comprising:
transmitting, by a duty cycle controller, a PEMFC duty cycle D₁ to a PEMFC boost converter, a battery duty cycle D₂₃ to a battery buck/boost converter, and a UC duty cycle D₄₅ to a UC buck/boost converter, wherein the PEMFC boost converter, the battery buck/boost converter, and the UC buck/boost converter are each connected in parallel with a DC bus;
generating a PEMFC current I_{FC} by the PEMFC module;
transmitting, by the PEMFC boost converter, the PEMFC current I_{FC} to the DC bus at a timing defined by the duty cycle D₁;
generating a battery current I_{b} by the battery module;
transmitting, by the battery buck/boost converter, the battery current I_{b} to the DC bus at a timing defined by the duty cycle D₃;
generating a UC current I_{UC} by the UC module;
transmitting, by the UC buck/boost converter, the UC current I_{UC} to the DC bus at a timing defined by the duty cycle D₄₅; and
transmitting a DC bus load current I_{L} to a load.

18. The method of claim 17, further comprising:
receiving, by an energy management controller, the DC bus load current I_{L};
generating, by the energy management controller, a reference PEMFC current I_{FC}*, a reference battery current I_{b}* and a reference UC current I_{UC}*;
receiving, at a DC bus connection port of the duty cycle controller, the bus voltage V₀;
receiving, at a first input port of the duty cycle controller, the PEMFC current I_{FC};
receiving, at a second input port of the duty cycle controller, the battery current I_{b};
receiving, at a third input port of the duty cycle controller, the UC current I_{UC};
receiving, at a first reference input port of the duty cycle controller, a reference bus voltage V₀*;
receiving, at a second reference input port of the duty cycle controller, the reference PEMFC current I*_{FC};
receiving, at a third reference input port of the duty cycle controller, the reference battery current I_{b}*;
receiving, at a fourth reference input port of the duty cycle controller, the reference UC current I_{UC}*;
subtracting, by the duty cycle controller which includes a circuitry, a memory storing program instructions and at least one processor configured for executing the program instructions, the reference voltage V₀* from the bus voltage V₀;
subtracting, by the duty cycle controller, the reference PEMFC current I_{FC}* from the PEMFC current I_{FC}, and generating the PEMFC duty cycle D₁,
subtracting, by the duty cycle controller, the reference battery current I_{b}* from the battery current I_{b}, and generating the battery duty cycle D₂₃,
subtracting, by the duty cycle controller, the reference UC current, I_{UC}* from the UC current I_{UC} and generating the UC duty cycle D₄₅; and
transmitting, by the duty cycle controller, the PEMFC duty cycle D₁, the battery duty cycle D₂₃ and the UC duty cycle D₄₅, to the PEMFC boost converter, the battery buck/boost converter and the UC buck/boost converter, respectively.

19. The method of claim 18, further comprising:
determining a set of tracking error variables,
relating the tracking error variables to the duty cycles D₁, D₂₃ and D₄₅;
formulating a stored energy function consisting of the sum of a resistive heat produced by the currents I_{FC}, I_{b} and I_{UC} flowing through the PEMFC, the battery, the ultra-capacitor and the DC bus;
calculating a time derivative of the stored energy function;
formulating a first equation which defines the PEMFC duty cycle D₁ in terms of each component of the PEMFC current I_{FC} in the PEMFC module minus the reference PEMFC current I_{FC}* minus an auxiliary term v₁;
formulating a second equation which defines the battery duty cycle D₂₃ in terms of each component of the battery current I_{FC} in the battery module minus the reference battery current I_{b}* minus an auxiliary term v₂;
formulating a third equation which defines the UC duty cycle D₄₅ in terms of each component of the UC current I_{UC} in the UC module minus the reference UC current I_{UC}* minus an auxiliary term v₃; and
formulating a fourth equation which defines the reference bus voltage V₀* in terms of a voltage component of the bus voltage which includes a sum of a PEMFC voltage generated across the bus capacitor by the PEMFC current I_{FC}, a battery voltage generated across the bus capacitor by the battery current I_{b}, a UC voltage generated across the bus capacitor by the UC current I_{UC}, an auxiliary term v₄, minus a load voltage generated across the bus capacitor by the load current I_{L}.

20. The method of claim 19, further comprising:
substituting the first equation, the second equation, the third equation and the fourth equation into the derivative of the stored energy function to formulate the stored energy equation in terms of the auxiliary terms v₁, v₂, v₃ and v₄;
formulating a set of fractional order sliding mode surfaces from the derivative of the stored energy function;
redefining the auxiliary terms v₁, v₂, v₃ and v₄ by the set of fractional order sliding mode surfaces respectively, wherein each redefined auxiliary term v₁, v₂, v₃ and v₄ includes an energy shaping term and a robust term which includes hyperbolic tangent of respective sliding mode surface;
substituting the redefined auxiliary terms into the stored energy equation; and
bounding the stored energy equation by an equation formulated to include a weighted sum of a squared value of each tracking error minus an absolute value of each tracking error, wherein the bounded stored energy equation is configured for forcing the PEMFC current I_{FC} to converge to the reference PEMFC current I_{FC}*, the battery current I_{b} to converge to the reference battery current I_{b}*, the UC current I_{UC} to converge to the reference UC current, I_{UC}* and the bus voltage V₀ to converge to the bus voltage reference V₀*.
